(19) United States
(12) Patent Application Publication
(10) Pub. No.: US 2008/0061559 A1
(43) Pub. Date: Mar. 13, 2008

(54) Use of Air Internal Energy and Devices

(76) Inventor: Israel Hirshberg, Alfei Menashe (IL)

Correspondence Address: Kevin D. McCarthy;Roach Brown McCarthy & Gruber, 420 Main St. - 1620 Liberty Bldg., Buffalo, NY, 14202, US

(21) Appl. No.: 11/667,798

(22) PCT Filed: Nov. 16, 2005
(86) PCT No.: PCT/IL05/01208

§ 371 Date: Jul. 2, 2007

(30) Foreign Application Priority Data
Nov. 16, 2004 (IL) 165233

(51) Int. Cl. F03D 9/00

(52) U.S. Cl. 290/55; 415/108; 415/115; 415/176; 415/202; 60/204

(57) ABSTRACT

A method of converting air internal energy into useful kinetic energy is based on air flowing through substantially convergent nozzle, which accelerates the air as the cross section of the nozzle decreases thus increasing the air kinetic energy. The increment of the kinetic energy equals to the decrement of air internal energy, i.e., air temperature. Within said nozzle a turbine is placed to convert airflow kinetic energy into mechanical energy that transformed into electrical energy or transferred into a gearbox to provide driving moment. Devices uses this method could use natural wind as airflow source or artificial airflow means. Devices, which incorporate means to create airflow artificially, can be used as engines for land, sea and flying vehicle. Since air temperature drops within the nozzle, moisture condensation exists and liquid water can be accumulated for further use.

### FIELD OF THE INVENTION

The present invention relates to methods and devices for increasing gas kinetic energy and generating electricity or mechanical energy from said energy.

### BACKGROUND OF THE INVENTION

Today, wind turbines are quite popular in windy areas. Their design is similar to aircraft propellers. They are mounted on high towers to face the natural wind, which cause them to rotate and this rotation drives generators that generate electricity. A minimum wind speed of about 4 meters per second is required to start rotating the propeller. The electricity generated by the generator is then used by the turbine owners or transferred to an electrical grid.

A good example for such a product is made by the a leading manufacturer in this field. The following data describes a 2 Megawatt generating machine.

Diameter: 80 meter

Swept area: 5,027 SQ meter

Number of blades: 3

Tower Data

Hub height (approx.) 60-67-78-100 meter

Operational Data

Cut-in wind: 4 meter/seconds

Nominal wind speed: 15 meter/second

Stop wind speed 25 meter/second (maximum operable speed of this machine)

Generator

Nominal output: 2000 Kilo Watt

Weight

Tower (60 meter) 110 ton

Nacelle: 61 ton

Rotor (propeller) 34 ton

TOTAL: 205 ton

Note: higher towers means more weight.

This giant machine nominal output is 2 megawatts power at a nominal wind speed of 15 meter/second.

When the wind turbine propeller rotates, only fraction of the flowing air within the circle created by the propeller tips is actually flowing close enough to any of the propeller blades in order to generates aerodynamic lift on that blade. These lift forces (actually their component that lies within the propeller rotating plane and tangent to circle created by the blade segment that generates said lift component) distributed along the propeller blades create rotational moments around the propeller axis. The lift forces multiplied by their respective distance from the propeller rotating axis accumulated to a certain amount of torque, which rotate the propeller blades. Since considerable amount of air is flowing between the propeller blades, this air doesn't contribute any lift or torque to the propeller. This is one reason why such a propeller uses only about 20% of the kinetic energy of the air crossing the propeller circle. Consequently, to generate enough power at low wind speed, a giant propeller is required.

As a result of this low efficiency, these wind turbines must be big in order to generate substantial electrical power. Therefore they are big, heavy and expensive and their moving blades are dangerous to birds and aircraft. Therefore these wind turbines are not installed on buildings of cities, where electrical power is in great demand.

Generating electricity out of wind is highly desirable for many reasons: it is clean non polluting energy source, it doesn't generate CO₂ and wind is free of charge, therefore it is a cheap source for clean energy however wind is sometimes too weak to run this giant propellers.

It is therefore desirable to have wind turbines that are more efficient, having a compact size and at lower manufacturing cost that can be installed on roofs of city buildings.

Another inherent flaw of these wind turbines is their limit to operate on strong winds. This is because the propeller blades are heavy—about 11 tons thus the centrifugal forces at high rotation speed becomes huge and there is no economic justification to design these blades to winds more than 25 meter per second.

### SUMMARY OF THE INVENTION

According to the present invention, there is provided a method and system to convert gas internal energy into kinetic energy and converting the gas kinetic energy into mechanical energy, which is converted into electrical energy.

A major aspect of the present invention is the use of convergent nozzle facing a coming wind, where the cross sections' areas of the nozzle decrease downstream so that the air speed increases, i.e., airflow internal energy is converted into kinetic energy.

Another aspect of the invention is the combination of air turbine, placed at the exit of the convergent nozzle so that the air exiting the nozzle driving the air-turbine.

Yet another aspect of the invention is that the rotation of the air-turbine drives an electrical generator that generates electricity out of rotation power.

Another aspect of the invention is that the turbine rotor's rotating axis is perpendicular to the airflow direction.

Yet another aspect of the invention is that the turbine convergent nozzle incorporates guide vanes, which direct at air flow within the nozzle.

Yet another aspect of the invention is that a turbine blade has the shape and size of the nozzle throat.

Yet another aspect of the invention is a variable nozzle inlet cross section.

Yet another aspect of the invention is the incorporation of a control system that monitors air speed at the nozzle throat and changes the nozzle inlet area in order to achieve maximum air speed at the throat without exceeding local speed of sound.

Still another aspect of the invention is the incorporation of control system that opens or closes an opening at the nozzle throat to allow air surplus spill out.

Still another aspect of the invention is that the accelerated air temperature decreases compared to the natural wind temperature.

Still another aspect of the invention is the starting process, which rotates the turbine for less than a minute in order to suck air from the nozzle, thus preventing static pressure rise within the nozzle and establishing steady state flow through the nozzle.

Still another aspect of the invention is the incorporation of automatic control system that directs the nozzle inlet towards the coming wind.

Still another aspect of the invention is a rectangular nozzle inlet.

Still another aspect of the invention is the separation of the convergent nozzle from its turbine and connecting the nozzle exit with the air-turbine by a pipe, which transfer the accelerated air from the nozzle to the turbine inlet.

Still another aspect of the invention is the use of impulse turbine together with the convergent nozzle.

Still another aspect of the invention is the generation of water out of water vapors within the airflow and clouds entering the turbine nozzle.
Still another aspect of the invention is a control system the changes a convergent-divergent nozzle throat in order to accelerate air within the nozzle to Mach=1.0.

Still another aspect of the invention is the incorporation of stop mechanism to hold and prevent the nozzle from rotating toward the wind.

Still another aspect of the invention is the incorporation of water drain system that prevents water from accumulating within the nozzle or the rotor chamber.

Still another aspect of the invention is a variable nozzle throat cross section area.

Still another aspect of the invention is the placement and displacement of air-turbine unit at the in the airflow exiting the nozzle.

Still another aspect of the invention is the use of a hoisting hook mounted on the wind turbine directly above the wind turbine center of gravity.

Still another aspect of the invention is that a turbine unit inserted into the throat of the convergent-divergent nozzle.

Still another aspect of the invention is that a turbine vertical rotation axis around it the turbine aligns to face the wind is ahead of the nozzle inlet.

Still another aspect of the invention is a convergent nozzle equipped with a powered fan that drives air into the nozzle so that the nozzle converts air internal energy into kinetic energy which drives a turbine that generates more power than given to the powered fan.

Still another aspect of the invention is a convergent nozzle equipped a powered fan and turbine that provides energy to said powered fan so that this combination is a turbo-prop engine driving an aircraft 19

Still another aspect of the invention is a convergent nozzle equipped a powered fan and turbine that mechanically drives said powered fan so that this combination is a turbo-prop engine driving an aircraft. 20

Still another aspect of the invention is an inner convergent nozzle equipped a powered fan and turbine that provides energy to said powered fan and additional fan that push air into another nozzle so that this combination is a turbo-prop engine driving an aircraft.

Still another aspect of the invention is an inner variable geometry convergent nozzle equipped a powered fan and turbine that provides energy to said powered fan and additional fan that pushes air into another variable geometry nozzle so that this combination is a turbo-prop engine driving an aircraft. 19,20

Still another aspect of the invention is an inner variable geometry convergent nozzle equipped a powered fan and turbine that provides energy to said powered fan and additional fan that pushes air into another variable geometry nozzle that change the flow direction so that this combination is a turbo-prop engine with thrust reverser, driving an aircraft.

Still another aspect of the invention is that said turboprop engine incorporates fuel injectors in the convergent nozzle to increase air flow energy and temperature thus increasing mass flow rate and speed of sound in the turbine to increase turbine energy production.

Still another aspect of the invention is a device that generates electricity from air internal energy independently of natural wind comprises a convergent nozzle equipped with first powered fan used to start the device and turbine that transfers air kinetic energy into mechanical energy which drives first turbine, second powered fan and electrical generator that generate electricity.

### BRIEF DESCRIPTION OF THE DRAWINGS

The present invention will be further understood and appreciated from the following detailed description taken in conjunction with the drawings in which:

FIG. 1 is a side view section along a wind turbine according to one embodiment of the invention having a convergent nozzle with circular inlet.

FIG. 2 is a front view of the wind turbine of FIG. 1.

FIG. 3 is a top view section along a wind turbine of FIG. 1.

FIG. 4 is a side view section along a wind turbine according to another embodiment of the invention having a rectangular inlet.

FIG. 5 is a front view of the wind turbine of FIG. 4.

FIG. 6 is a top view section along a wind turbine of FIG. 4.

FIG. 7 is a side view section along a wind turbine according to another embodiment of the invention having a variable cross section area inlet.

FIG. 8 is a front view of the wind turbine of FIG. 7.

FIG. 9 is a top view section along a wind turbine of FIG. 7.

FIG. 10 is a side view section along a wind turbine according to another embodiment of the invention having a winged rotor and stator with guide vanes.

FIG. 11 is a front view of the wind turbine of FIG. 10.

FIG. 12 is a section along a wind turbine according to another embodiment of the invention having axial impulse turbine.

FIG. 13 is section showing turbine shaft, supporting arms, stator disk and rotor disk of air turbine of FIG. 12.

FIG. 14 is a plan view of stator disk and rotor disk of FIG. 12.

FIG. 15 is a side view/section view along a wind turbine according to another embodiment of the invention having nozzle separated from the air-turbine.

FIG. 16 is a side view section along a wind turbine according to another embodiment of the invention having an convergent-divergent nozzle separated from the turbine.

FIG. 17 is a side view section along a wind turbine according to another embodiment of the invention having a vertical axis of rotation ahead of the convergent nozzle.

FIG. 18 is a side view section along a nozzle equipped with powered fan.

FIG. 19 is a side view section along a nozzle equipped with powered fan and turbine to become a turbo-prop engine for aircraft.

FIG. 20 is a side view section along a nozzle equipped with powered fans and turbine to become a two stage turbo-prop engine for aircraft.

FIG. 21 is a side view section along a nozzle equipped with powered fans, turbine and thrust reverser to become a two stage turbo-prop engine for aircraft.

FIG. 22 is a side view section along a nozzle equipped with powered fan and turbine to become two stage turbo-electric generator.

### DETAILED DESCRIPTION OF THE INVENTION

Today's wind turbines comprises of propellers, which are driven by airflow, i.e., wind. As wind increases, more kinetic energy is available to drive the propeller blades but since the propeller blades are big and heavy (about 11,000 kilograms per one blade), when the wind speed exceeds certain level, according to the blade strength and its attachment strength to the shaft, the rotation must be stopped to prevent centrifugal forces breaking the blade. Thus the air turbine stops its work and a lot of wind energy is wasted. On the other hand, when the wind is too weak, about 4 meter per second or less, even giant propellers are not put to work since the available kinetic energy is too small to rotate the giant air turbines. The present invention overcomes these obstacles and explains how the present invention air turbine can be compact and generates more electricity in weak winds as well as in high-speed winds.

Further, installing a powered fan that generates the airflow flowing into the nozzle inlet is worthwhile since the convergent-divergent nozzle is able to increase airflow kinetic energy at its throat by a factor of about ten, thus the net power output is larger than of the power input and we get an engine which is independent of wind. A powered fan that sucks air and pushes airflow into a convergent or convergent-divergent nozzle is a major aspect of the invention.

Wind kinetic energy can be expressed mathematically by this formula:
E_{K}=ρ×V×A×V²/2 Where V is the air speed
ρ is the air density
A is the cross section of the flowing air
“×” is the multiplication sign—it will be omitted afterwards.
Therefore, zero air speed yields zero kinetic energy.
(Note: All formulae in this patent application and the data used are taken from the reference book:
FOUNDATIONS OF AERODYNAMICS 2^{nd} Edition
BY: A. M. KUETHE and J. D. SCHETZER
Department of Aeronautical Engineering
University of Michigan (USA)
Publisher: JOHN WILEY & SONS
Library of Congress Catalog Card Number: 59-14122)
Surprisingly, natural wind air has huge amount of energy (called “internal” energy) compared to its kinetic energy even at freezing temperature.
To realize this statement, one must look at equation of energy for isentropic compressible flow for a unit mass:
CₚT+V²/2=const (Eq. 24 Ref. Book P140)
As we are discussing wind, all relevant parameters in the above equation relate to air in specific conditions where:
Cₚ is the constant pressure specific heat of air—see page 132 in the reference book
Cᵥ is the constant volume specific heat of air—see page 131 in the reference book
γ=1.4 is the ratio Cp/Cv for air under 1000° R
T is the absolute temperature of the air
V is the speed of the air

Cₚ×T is the internal energy of the gas (air) while V²/2 is the kinetic energy of gas unit mass. For isentropic flow (heat is not added or taken from the air), the energy relation given by Eq. 24 must be satisfied”, i.e., conservation of energy exists.

To demonstrate the ratio between kinetic energy and internal energy we calculate these energies for a relatively strong wind of 25 meter/second (the maximum operable wind speed of the V80 2 Megawatt wind-turbine) having a temperature of T=32° F., which is quite cold air in the populated northern hemisphere in the winter, where such air turbines are popular.

Using the British Unit System
Cp=6000 FT×LB/Slug° R
T=460+32=492° R
V=25/0.3048=82.02 FT/SEC
The internal energy is: CₚT=6000×492=2,952,000 FT×LB/Slug
The kinetic energy is: V²/2=(82.02)²/2=3,201.6 FT×LB/Slug
Therefore the ratio between the air kinetic energy to the air internal energy in this case is: 3,201.6/2,952,000=0.00108, i.e., the kinetic energy is about one thousandth of the air internal energy and this case is for the maximum operable air speed for the sophisticated 2 MW air turbine. Weaker winds yield even smaller energy ratios.

Since moderate wind (less than 10 meter/second) kinetic energy is small, large area rotor blades are required to increase the amount of energy collected by this type of wind turbine. Larger rotor blades make the entire machine as the V80 so big and expensive which consequently produces expensive electricity.

Therefore, it is amazing to realize that no one has come with a method to exploit the source of air internal energy. The present invention does this conversion of air internal energy into kinetic energy, which is then converted to mechanical energy by a novel turbine designs.

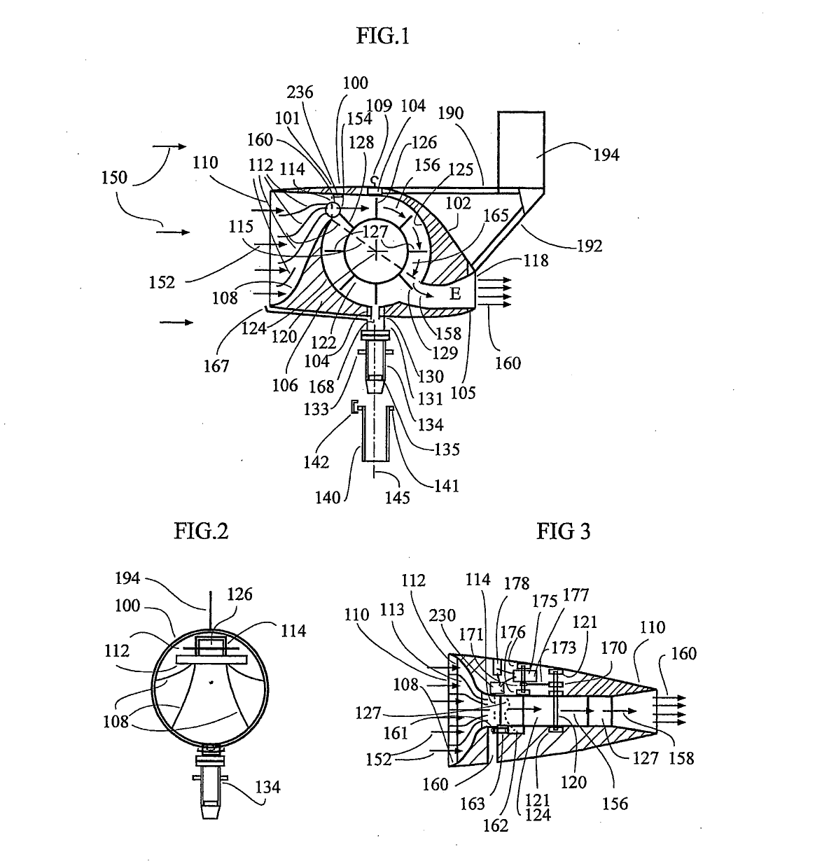

FIG. 1 schematically shows a section view along one embodiment of the invention. A pod 100, contains a cylindrical rotor 122 having blades 126,127, 128 etc. These blades can be planar or concave with rectangular plan-form, or any other plan-form shape. Thus when the wind 150 enters the nozzle inlet 110 and flows within the nozzle 108 as 152, further converges to the nozzle throat 114, where the nozzle cross section area is minimal, there the air reaches its maximum air speed. Immediately after the throat 114 the flowing air 154 meets the “rising” blade 128 and blade 126 which is instantaneously perpendicular to the air flow 154. The blade 126 is forced by the flowing air 154 to move rightward, i.e. rotates clockwise around the rotor axis of rotation 120, which is normal to the driving airflow 154. Since blade 126, 127, 128 and alike are firmly attached to the rotor cylinder 122, rotor 122 rotates clockwise with its blades 126, 127, 128 etc. The distance between the rotor blades' 126,127, 128 etc edges to the cylinder chamber walls 124, 125 is small (few millimeters) thus the flowing air 154, 156 cannot bypass these blades and force them to rotate while it flows inside the channel 162 until it reaches the opening 129 where the airflow 158 now leaves the rotor chamber through the exhaust nozzle designated by ‘E’ and leave the turbine cross section 118 as flow 159. The airflow route from rotor blade 126 up to rotor blade 129 provides time distance for the airflow to exert continuous aerodynamic force on the rotor blades while minimizing the number of the blades to 2, thus reducing the manufacturing cost of this air-turbine and eventually reduce the cost of electricity generated by this design. However, to maintain smooth operation, i.e., constant aerodynamic torque on the rotor 122, 4 to about 8 blades should be used. This design is a major aspect of the invention.

The pod 100 is equipped with a vertical wing 194 that stands in the free air, thus any wind which is not aligned with the vertical wing 194 plane, exert aerodynamic force on the wing and this force rotates the pod 100 around its vertical axis 145 through a mounting column 134 so that the pod inlet 110 faces the coming wind 150.

The pod column 134 is equipped with a stop 133 and a leading cone 135 both firmly attached to 134. which helps in aligning the column 134 into the pipe 140, which is the tower on which the pod 100 is mounted for operation, i.e., generating electricity from wind. After inserting column 134 into pipe 140, the stop 133 stops the down movement of 134 into 140 when it meets its counterpart 141. Both 133 and 141 have the same planar shape, preferable a circular plan-form. When 133 rest on 141 a lock 142 having a c shape cross section is installed firmly to the lower 141 (preferably by bolts) thus enabling 133 and the entire pod 100 to rotate around axis 145, toward the coming wind but not moving upward, thus keeping the turbine pod installed on its carrying column 140. The mounting system 130 to 140 is another aspect of the invention.

Hook 109 is attached exactly on the pod plane of symmetry above the center of gravity thus when a crane delivers the pod for installation on column 140, the column 134 will be perpendicular to the horizon and parallel to column 140 thus enabling easy aligning of the cone 135 into the column 140 top opening to allow easy installation of the turbine at its working location. This hook and its location is another aspect of the invention. An optional surplus air passage is provided for extremely high-speed wind, which might cause Mach number in the throat to exceed 1.0, i.e. speed of sound. In such a case an optional control system, incorporating air speed measuring device in the nozzle 108, will open this air passage to let excess airflow to exit the nozzle through this passage without exceeding M=1.0 at the throat section 114 which cause noise and rumbling.

Since the present invention air-turbine operates in a rather close container, water drainage system is required to remove rain waters accumulate within the nozzle or at the rotor chamber. Moreover, since air entering the nozzle is chilled (see numerical example later), water vapors could liquidize into water. To drain water from the air-turbine, a water collector 167 is added and it collects water from the convergent nozzle and transfer them to pipe 131. Also a drainage hole and pipe 168 collects water from the rotor chamber. In arid area, this water could be used for any usage since these are clean potable waters. If the turbine is placed in areas where clouds present, i.e. top of mountains or high towers, than significant amount of water could be generated and stored for later use. The water collecting and draining system is another embodiment of the invention.

The rotor design of FIG. 1 assure high efficiency since the airflow cannot bypass the blades as the distance between the chamber walls and the blade edges are about 1 or 2 millimeters while to the blade span or chord are about 30 centimeters or more. As a result of this geometry, the airflow cannot bypass the blade and must push the blade so that much of the air kinetic energy is transferred to the blade by giving the blade same speed as the airflow speed. The blades could be simple planar sheet metal or other material thus lowering the manufacturing cost of this blade. On the other hand, concave blades could provide even greater aerodynamic efficiency as well as structural strength. Thus the blades in FIG. 1 could have concave design. The rotor blades in this design are significantly smaller compared to air turbine using propellers. Aerodynamically efficient propellers span should have a length of at least about 10 times of the propeller chord. Thus for the 2 MW machine, each blade length is about 40 meters and weighs about 11 metric tons! When this blade rotates, it generates considerable centrifugal force that could tear the blade from its shaft. Since the centrifugal force of the blade is:
F=∫ω²Rdm,

ω is the rotational speed

R is the local radius of mass element of the propeller blade

dm is a differential mass element of the propeller blade

As the blade rotation speed increases, it generates more centrifugal forces on its shaft. This is the reason why propeller based air turbine must be stopped at high speed winds. In the present invention the blades' spans are short, their mass are small, thus the entire rotor assembly is small and light which makes the centrifugal forces acting on the rotor and rotor blades much smaller than propeller type wind turbine. Therefore, the embodiments of this application able to rotate at much greater speed without the need to heavily strengthen the rotor structure.

Consequently, the low rotor weight reduces the rotor rotational moment of inertia, which makes the starting of rotation by airflow much easier than the current wind-turbines. The rotation speed of the rotor is an important factor to get high output power since the power is equal to the multiplication of direct force multiply by speed, i.e.: P=F×V.

Further, in this embodiment, aerodynamic force acting on the rotor blades, are a combination of “lift” and drag. In this embodiment stall is meaningless since we are interested in the combined effect of aerodynamic force normal to the blade. Therefore lift and drag serve the same goal of increasing the force normal to the blade major plane and this combination of forces makes the force more stable. Therefore, for this rotor embodiment we regard the aerodynamic force as drag. The drag coefficient for this embodiment is in the range of 1.0 to 2.0 for a square blade hit by normal flow. Thus, a design based on aerodynamic drag is another aspect of the invention.

In aircraft wings as well as in propeller blades, the wing is geometrically constructed from wing profiles such as NACA 65 series. Each wing profile has a chord, which is defined as the line connecting the leading edge and the trailing edge. In this embodiment, the wing is attached to the rotor hub by its profiles' trailing edges area, unlike propeller blades or turbojet engine axial turbines, where the blades are connected to the hubs through entire profile area. Thus, the rotor design with lightweight rotor blades, connected to the hub through profiles' trailing edges area and moving with the airflow along the airflow route in a close chamber, are additional aspects of the invention.

The convergent nozzle 108 is a major aspect of the invention. The nozzle cross section areas gradually decrease toward the throat 114, where the nozzle cross section area is the smallest, thus force the air flow 152 to accelerate, i.e., converting air internal energy into kinetic energy.

To minimize kinetic energy losses due to turbulence and to prevent static pressure rise within the nozzle, the inlet 108 is provided with guide vanes 112. These are planar and thin rigid elements (made of metal, plastic or composites like carbon fiber, glass fiber and so) that force the airflow to flow in streamlines “parallel” to each other and to have the general direction of the nozzle walls so that the airflows leaving the guide vanes flows toward the throat 114 have the same speed and flow as smooth as possible without intermixing, are parallel to the nozzle walls at throat 114 and normal to rotor blade 126. Arrow 154 demonstrates this flow. The convergent nozzle design, which incorporates guide vanes to reduce turbulence and static pressure rise within the nozzle is another aspect of the invention.

The throat 114 cross section area, which is about 1/10 of the inlet cross section 110, causes airflow speed 150 to increase about ten times compared to natural wind speed, while increasing its kinetic energy by factor of about 100. The length and shape of the nozzle is a matter of tradeoff between efficiency and weight consideration since longer nozzle is better for preventing turbulence and pressure rise, which are important to get isentropic flow and the ability of the nozzle to transfer as mach air mass as possible while minimizing the inlet spillage. The convergent nozzle that converts airflow internal energy into kinetic energy is a major aspect of the invention.

To prove this high kinetic energy gain we shall calculate the air parameters along the nozzle from the inlet up to the throat:

Inlet cross section 110 airflow parameters:

A₁=10 M² cross section area at 110
V₁=21.737 FT/SEC wind speed at 110 (please note that this value is chosen to make the numerical calculations later, easier.)
ρ₁=0.002378 Slug/FT³ air density at 110 (standard atmospheric value at sea level)
T₁=32° F. air temperature at 110 (average winter air temperature)

And we need to know the same parameters at throat 114 where the airflow hits the turbine blades 128 and 126, i.e.:
A₂=1 M² cross section area at 110—given by design
V₂=? wind speed at 114
ρ₂=? air density at 114
T₂=air temperature at 114
γ=1.4 is the ratio Cp/Cv for air under 1000° R
   Solution: using the following equations:
   1) [CₚT+V²/2]₁₁₄=const=CₚT₀]₁₁₀; unknowns: T, V at section 114

Energy conservation; EQ 24 p. 140 in the Ref book.

2) p=ρRT; unknowns: T, p, ρ at section 114

Ideal gas equation of state; EQ 2 p. 130 in the Ref book.

3) [ρVA]=constant; unknowns: ρ, V at section 114

Continuity Equation; EQ 22 p. 155 in the Ref book.

4) T/ρ^{γ-1}=C=T₀/ρ₀^{γ-1}; unknowns: T, ρ at section 114

Adiabatic reversible flow EQ. 29 p. 142 the Ref book.

(T₀ and ρ₀ at section 114 have the same values as in section 110 for adiabatic flow and can be calculated using EQ. 1 and 4 with the given parameters) we have 4 unknowns V, T, p and ρ which are the airflow parameters at section 114. Since solving this set of equations eventually requires trial and error method because of Equation No. 4 above, the reference book further developed the solution in pages 152-159. The generalized solution is explained using the definition of Mach number instead of airflow speed V and the solutions are shown in FIG. 4 P. 153 of the reference book and in table 2 from this book.

### TABLES

TABLE 2
FLOW PARAMETERS VERSUS M FOR SUBSONIC FLOW

| M | p/p₀ | ρ/ρ₀ | T/T₀ | a/a₀ | A*/A |
|---|---|---|---|---|---|
| .00 | 1.0000 | 1.0000 | 1.0000 | 1.0000 | .00000 |
| .01 | .9999 | 1.0000 | 1.0000 | 1.0000 | .01728 |
| .02 | .9997 | .9998 | .9999 | 1.0000 | .03455 |
| .03 | .9994 | .9996 | .9998 | .9999 | .05181 |
| .04 | .9989 | .9992 | .9997 | .9998 | .06905 |
| .05 | .9983 | .9988 | .9995 | .9998 | .08627 |
| .06 | .9975 | .9982 | .9993 | .9996 | .1035 |
| .07 | .9966 | .9976 | .9990 | .9995 | .1206 |
| .08 | .9955 | .9968 | .9987 | .9994 | .1377 |
| .09 | .9944 | .9960 | .9984 | .9992 | .1548 |
| .10 | .9930 | .9950 | .9980 | .9990 | .1718 |
| .11 | .9916 | .9940 | .9976 | .9988 | .1887 |
| .12 | .9900 | .9928 | .9971 | .9986 | .2056 |
| .13 | .9883 | .9916 | .9966 | .9983 | .2224 |
| .14 | .9864 | .9903 | .9961 | .9980 | .2391 |
| .15 | .9844 | .9888 | .9955 | .9978 | .2557 |
| .16 | .9823 | .9873 | .9949 | .9974 | .2723 |
| .17 | .9800 | .9857 | .9943 | .9971 | .2887 |
| .18 | .9776 | .9840 | .9936 | .9908 | .3051 |
| .19 | .9751 | .9822 | .9928 | .9964 | .3213 |
| .20 | .9725 | .9803 | .9921 | .9960 | .3374 |
| .21 | .9697 | .9783 | .9913 | .9956 | .3534 |
| .22 | .9668 | .9762 | .9904 | .9952 | .3693 |
| .23 | .9638 | .9740 | .9895 | .9948 | .3851 |
| .24 | .9607 | .9718 | .9886 | .9943 | .4007 |
| .25 | .9575 | .9694 | .9877 | .9938 | .4162 |
| .26 | .9541 | .9670 | .9867 | .9933 | .4315 |
| .27 | .9506 | .9645 | .9856 | .9928 | .4467 |
| .28 | .9470 | .9619 | .9846 | .9923 | .4618 |
| .29 | .9433 | .9592 | .9835 | .9917 | .4767 |
| .30 | .9395 | .9564 | .9823 | .9911 | .4914 |
| .31 | .9355 | .9535 | .9811 | .9905 | .5059 |
| .32 | .9315 | .9506 | .9799 | .9899 | .5203 |
| .33 | .9274 | .9476 | .9787 | .9893 | .5345 |
| .34 | .9231 | .9445 | .9774 | .9886 | .5486 |

Numerical values taken from NACA TN 1428, courtesy of the National Advisory Committee for Aeronautics.

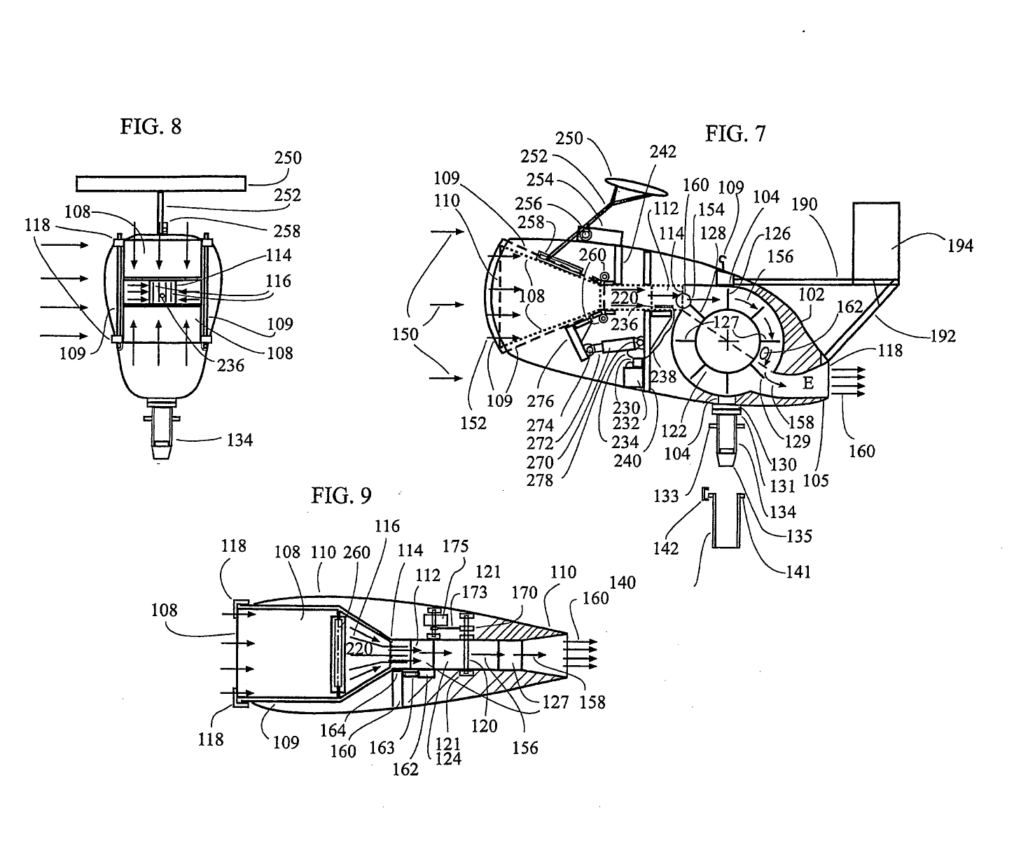

The discussion in the reference book continues for convergent-divergent nozzle named “Laval Nozzle”, see P. 156 to 159 where the solution is given using the definition of critical area A* where local Mach=1.0 (P. 157 L. 2). The flow parameters are given in Eqs 26, 27 in P 157 and in FIGS. 7,8 in P. 158. The term A*/A is very helpful in calculating airflow parameters and is included in Table 2.

The method of solving flow parameters in a convergent nozzle is done according to the following method:

Step 1: Calculating the ratio A*/A for a Mach number specified for section 110:

Calculating the cross section area A* in the convergent nozzle where the air flow reaches Mach 1.0, i.e., the speed of sound. Please note that the speed of sound a is a function of T:

a=√γRT Therefore we shall calculate the Mach number at Section 110:

speed of sound in section 110 is:
a]_{S110}=√1.4×1715×(460+32)=1086.87 FT/SEC
Since the Mach number at section 110 is: M=V/a=21.737/1086.87=0.02
For this value in table 2 we get A*/A]_{S110}=0.03455=>A*/10=0.03455=>A*=0.3455 M²
Step 2: Calculating Mach number at section 114:
Since A* is known and A]_{S114}=1.0 SQ. meter, then A*/A for section 114 is:
A*/A=0.3455/1.0 this value is found for in table 2 for an interpolated data line where M=0.205—an interpolation between the lines for M=0.2 and M=0.21. In this interpolated line of data we get:
(note: T⁰ is directly calculated for station 110 from EQ 1 presented before)
T/T⁰=0.9921=>T]_{S114}=T⁰×0.9921=492.03937×0.9921=488.15° R.
T]_{S114}=488.15° R and this means that air in section 114 is colder than the air entered the nozzle inlet 110 (492° R). This airflow temperature decrease is an important aspect of the invention since it can be used to get water from clouds swallowed by a convergent nozzle according to this invention.
Step 3: Calculating the speed of sound in section 114:
a=√(γRT)=√(1.4×1715×488.15)=>a=1082.61 FT/SEC
Step 4: Calculating the airflow speed in Section 114:
V=a×M=1082.61×0.205=221.93 FT/SEC
Thus the air speed at the throat 114 is 221.9 FT/SEC, which is 221.9/21.737=10.2 times faster than the airflow speed at section 110. Therefore we get airflow having 104 times more kinetic energy in section 114 compared to section 110. This huge increase of kinetic energy is the major aspect of the invention. Since no external forces was implied on the airflow in the nozzle, some of the airflow internal energy of section 110, i.e.:
ΔT×Cp=(492−488.15)×6000.
has been converted into kinetic energy, i.e.: V²]_{S114}/2−V²]_{S110}/2=(221.9²−21.737²)/2 and this is the major aspect of the invention.
Please note that the density pressure and temperature at station 114 can be easily calculated from the values of table for M=0.205 after calculating ρ⁰ from EQ 4 and p⁰ from EQ 2.

It should be noted that the above calculations for convergent nozzle is based on “small rate of change of cross section or between parallel streamlines” see P 154 in the reference book. Therefore some deviation from the ideal nozzle should be expected for a nozzle which has more than “small rate of change of cross section” however the continuity equation: ρVA=constant is obeyed in any case and this equation dictates the acceleration of the airflow in steady state once the airflow enters the nozzle and has a steady state speed at section 110.

We can check this easily by using the energy Eq. 24:
CₚT]₁₁₀+V²/2]₁₁₀=const=CₚT]₁₁₄+V²/2]₁₁₄
6000×492+21.737²/2]_{S110}=? 6000×488.15+221.9²/2]_{S114}
2,952,236.=? 2,953,520
Although there is a small difference between numbers, the ratio between them is 0.99956, which is excellent accuracy for engineering purposes keeping in mind the inherent inaccuracy of using rounded parameters from table parameters and the interpolation used for the Mach number. To amend this deviation:
T]_{S114}=(2,952,236−221.9²/2)/6000=487.936° R. Thus the difference in T is about 0.2° which is a negligible error.
Thus, using a convergent nozzle of area ratio 1/10 the wind natural speed of 21.737 Ft/SEC have been increased to 221.9 FT/SEC and the natural wind kinetic energy per unit mass have been increased from 21.737²/2=236.25 to 221.9²/2=24,619.8 which increase of kinetic energy by a factor of 104, on the expense of the air temperature decrease. This conversion of internal energy into kinetic energy is the major aspect of the invention. Since by using this convergent nozzle we get high-speed air flow concentrated in small area, which is 1/10 of the inlet and the airflow is confined by the convergent nozzle, we need small turbine blade which is lighter and much more efficient in converting air kinetic energy into mechanical energy.
FIG. 1 demonstrates one embodiment to accomplish this. The length of the nozzle from the inlet cross section to the throat cross section 114 should be as short as possible to reduce the weight of the nozzle and increase its rigidity for a given mass structure so it can stand and operates even in hurricanes. However, the convergent nozzle should be long enough to assure isentropic flow and minimum inlet spillage. To achieve these contradictories requirement guide vanes are used. The guide vanes 112 divide the nozzle 108 into 4 independent convergent sub-nozzles, each with the area ratio of inlet versus exit of about 1/10 so that the flows exit each sub-nozzle will have the same speed to prevent turbulence. Note that each sub-nozzle is much more slender than of the major nozzle. The desired number of sub-nozzles is a matter of trade off since adding a sub-nozzle increases drag, weight and complexity and cost, all unwelcome. Using guide vanes in nozzles and especially in short convergent nozzle is another major aspect of the invention.

It should be noted that in order to make this invention to be efficient, the static air pressure inside the convergent nozzle should be less than the static pressure upstream, i.e., at the inlet 110. This is the case when the air is accelerating through the convergent nozzle in an isentropic flow. Since a turbine coupled to a generator is placed in the throat or slightly after the throat, its presence forms aerodynamic resistance to the flow, especially in case of high output power generators. To over come this starting problem, an optional “starting” procedure could be used to give the turbine initial rotating speed that sucks air from the nozzle and help in establishing steady state airflow in the nozzle. Connecting the generator to external electrical power source so that the generator acts as electrical motor that rotates the turbine connected to it does this. This starting process should be done when a wind is present. Such an external power source is a battery or the electrical grid. The generator charges this battery when the wind turbine generates electricity and the battery provides electrical current on starting time. The starting process elapsed time is short and takes a about 1 minute or so and then stopped to allow the steady state airflow air to drive the turbine blades by its own power. This starting process is another aspect of the invention.

To initiate the starting procedure many arrangements can be made. For example, a motion sensor, installed on the wind turbine, generates an electrical signal which is amplified by an amplifying circuit, powered by the battery, switches a relay, which connect the battery to the generator via a timer. The timer transfers the electrical current to the motor/generator and after a predetermined time of several seconds disconnects the power to the motor.

Another arrangement is by incorporating a Pitot tube inside the nozzle or outside it to actually sense any airflow. The rise of pressure within the Pitot tube due airflow entering the Pitot tube is converted into electrical signal, analog or digital, which arrives at a control system 230, triggers the control system to operates the starter system by connecting the battery's terminals to the electrical motor connected to the air turbine rotor. After starting the turbine the control system cannot initiate another starting for at least 5 minutes or more to allow only natural wind to initiate starting and not the airflow generated by the air-turbine in the starting process. The control system is based on a CPU (central processor unit), memory device that save a computer program that monitors the state of the wind-turbine and “decide” when to initiate the starting process depending on the presence of minimum natural wind airspeed data coming from the Pitot tube. Also, the data from table 2 as well as atmospheric data could be stored in the memory device. This data is required for controlling the surplus air passage 161—see additional details with regard to FIG. 3—or other features of other embodiments of the invention. Other methods to start the turbines could be applied such a pre programmed timer that start rotating the turbine at predetermine times or time intervals; operating command arrives from remote control device or even human manual command operating electrical switch to operate a wind-turbine for home usage according to the invention.

A great advantage of this invention is its ability to generate significant amount of energy even at low wind speed and compact size, so such a device could be easily installed on a roof of every building. For example, we shall calculate the power output of 1 meter inlet diameter convergent nozzle according to FIG. 1.

Assuming wind speed of 21.737 FT/SEC, i.e. 6.6 Meter/SEC a very common weak wind, yielding airspeed of 221.9 FT/SEC at the throat 114. We now calculate the aerodynamic force acting on blade 126 which is temporarily normal to throat air flow 54 having a speed of 221.9 FT/SEC.

We shall use throat data calculated before—see pages 16-17 and calculate the air density at the throat using the interpolated ratio ρ/ρ₀=0.9793
ρ=ρ₀×0.9793=0.002378*0.9793=0.0023288
F=½ρV²SC_{D} where S is the blade 126 area and C_{D}=1.0 is the drag coefficient of the blade 126 (section 114).

Since the turbine blades restrain the airflow within the nozzle throat, we now assume an airflow speed decrease of 30% in the throat comparing to the airflow speed with turbine load, i.e. the airflow speed is 221.9×0.7=155.3 FT/SEC
S]_{S114}=(π×1²/4)×10.76)/10=0.845 SQ-FT
F=0.5×0.0023288×155.3²×0.845×1.0=23.669.5 Lb=105.3 Newton
And the power is
P=F×V=105.3×(155.3*0.3048 [Meter/SEC])=4984.8 Watt
We shall now calculate the airflow energy at the throat without turbine load:

$$\begin{matrix}Ek = 0.5 {MV}^{2} \\ = 0.5 \times ρ V \times A \times {V}^{2} \\ = 0.5 \times 0.0023288 \times 221.9 \times 0.845 \times {221.9}^{2} \\ = 10 \text{,} 722.8 [ FT \text{-} LB ] \\ = 10 \text{,} 722.8 \times 0.3048 \times 0.454 \times 9.8 \\ = 14 \text{,} 541.3 Joule \text{/} SEC\end{matrix}$$

Therefore, the above power output calculation, which shows that this wind-turbine generates 5 kilo Watt out of 14.5 kilo Watt is very conservative and the actual power output could be around 7 kilo Watt.
This output power of 5.0 Kilowatt is enough for an average family in the western countries.
This output power produced out of light wind of 6.6 meter/second, stronger winds wills double this figure and more.
Since this wind turbine length is about 2.5 meters, it size allows any city building rooftop to have such a wind-turbine for thousands families in each city. Adopting this invention could save a country significant amount of electricity, pollution and give many families a way to reduce living cost by generating their own electricity. Naturally, at higher wind speed a owner of such wind turbine could sell the electricity to a local power company.

FIG. 2 shows a front view of the air turbine of FIG. 1. All the numbered elements have the same numbers as in FIG. 1. This view shows that the guide vane 112 stretched across the nozzle width to treat the entire flow. The span of the guide vanes 112 is clearly seen in FIG. 3. The guide vanes dimensions are opted for minimum loss of kinetic energy that would heat the air. Vertical guide vanes—not shown in this Fig—could be added to prevent turbulence lateral flow turbulence effect.

FIG. 3 shows a top view cross section of the air turbine of FIG. 1. All the numbered elements have the same numbers as in FIG. 1 except for the items not shown in FIG. 1. The rotor main shaft 120 rotates due to aerodynamic forces exerted on its blades 127 (the rest of the blades are not shown to keep the drawing easy to read). The shaft 120 has a pulley 170 that engaged with a belt drive 173, which rotates a pulley 171, which has smaller diameter than pulley 170 thus pulley 171 rotates at high rotational speed sufficient to drive the electrical generator 175 that converts the mechanical energy into electrical energy. The electrical energy in the form of electrical current is transferred out of the generator by electrical wires, which are not shown.

The role of the of optional air surplus discharge system 160-163 is to make this design handle hurricanes, which could have wind speed of up to 300 kilometer per hour. Hurricane air speed increased by 10 exceeds Mach=1. To prevent wave shock within the nozzle, the air passage 160 will open thus increasing the throat area, which lower the airspeed at throat 114 to keep it under Mach=1.0. The incorporation of surplus air-passage is another aspect of the invention. A control system 230 integrated with an airspeed measuring device 236, such as a Pitot tube that measure the stagnation pressure in the throat and an analog to digital converter (not shown) converts this pressure into electrical signal passed through lines 238 to the control system CPU. The CPU run a computer program that monitors the airflow speed at the throat and when this speed reaches M=1, opens the electrically operated door 161 by the remote control electrical actuator 162 and its arm 163. Aerodynamic data (such as table 2 from the reference book) stored in the control system memory device serve the control system in various tasks of other embodiments of this application. When the Mach number increases toward Mach=1.0 the control system send an electrical signal to an electrical actuator (a common device in airplane industry) which pushes a rigid arm 163 that opens the door 161 thus some of the air before the throat can flow out through passage 160 and the airflow at the throat will not exceed M=1, thus preventing shock wave, noise and vibrations. Thus this optional air passage enable this wind-turbine operates in strong wind in order to exploit some energy from these devastating natural events. The incorporation of surplus air discharge system is another aspect of the invention.

FIG. 4 is a side view section of another embodiment of the invention, which demonstrate two dimensional inlet and even longer air route where air exert drag force on the rotor blades thus greater efficiency is achieved. All the other features of the design of FIG. 1 can be implied here and in any other embodiments of this application.

The elements designation numbers for FIGS. 4,5,6 are basically the same as for FIGS. 1,2 and 3.

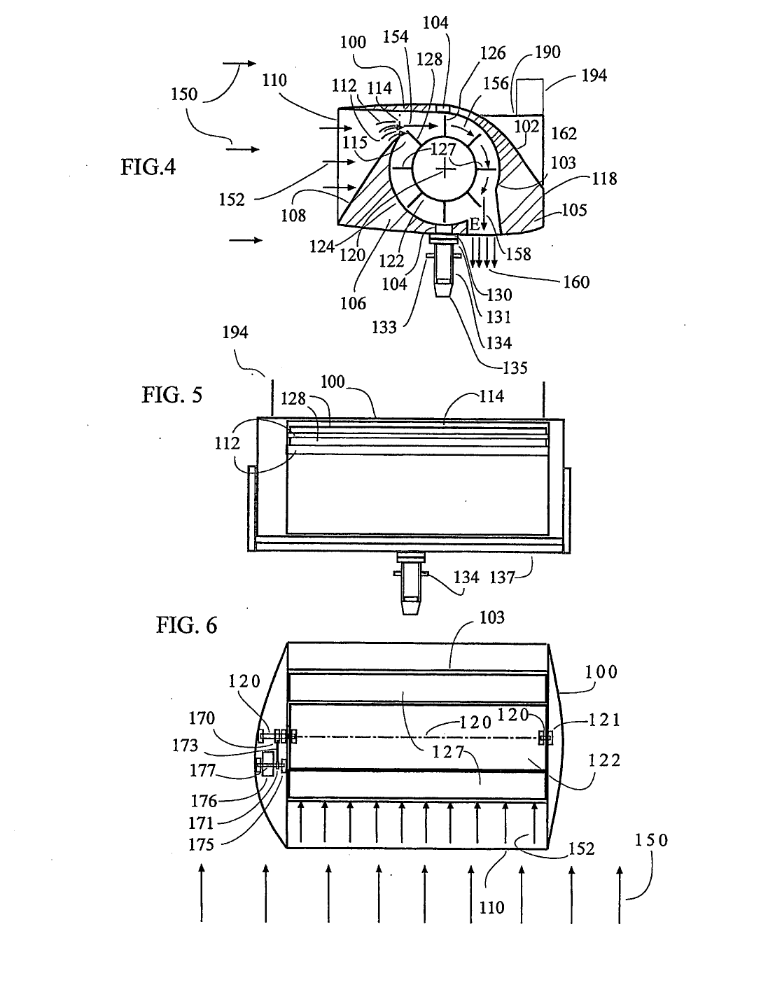

FIG. 5 shows a front view of the air turbine of FIG. 5. This embodiment has two dimensional air inlet. This enables the inlet to have large inlet area while keeping turbine rotor diameter small. This is very important to keep centrifugal forces low and consequently lighter structure and less expensive. On the other hand high power wind-turbines require big inlet and over all big impact on the natural landscape. However, this embodiment lowers the height of the design and gives it better appearance. Larger inlet area means more electricity produced.

FIG. 6 is a top view of the embodiment of FIG. 4. In this embodiment the rotor blades 127 spans are about 5 to 10 times greater than the blades' radius, i.e., chord—the length of the blade as seen in FIG. 1 or 4.

FIG. 7 is another embodiment of the invention, which has similar rotor design as in FIGS. 1 and 4 however here the nozzle has variable cross section areas. The advantage of variable inlet is in preventing airflow at the throat 114 reaching Mach=1, which will choke the flow while exerting overall large forces on the inlet when the wind speed increases.

For this embodiment of air-turbine, the size of rotor blade is fix and its maximum airspeed is M=1.0. Therefore, to optimize the power output, the inlet area should be adapted to the wind speed. Low wind speed requires increasing the inlet area while at high speed winds the inlet area could be decreased. To change the nozzle cross sections the embodiment comprises two planar surfaces 108 both have hinges 260, thus they can rotate around their hinges' 260 axes. To change the inlet cross section area 110 two optional mechanisms are described. The first is the wing 250, which its lift directed upwards, increases, as the wind speed increases. As a result of bigger lift force on wing 250 the attached arm 252 rotates around cylinder 256 and exert a downward force on the moveable planar surface 108, which rotates around hinge axis 260, thus surface 108 leading edge (the line that is the first to meet the coming wind) rotates downward and reduces the inlet cross section area 110.

Another option to change the nozzle area is by the electronic control system 230. The control system described with respect to the surplus air passage 160 of FIG. 1. Here the CPU monitors the airflow speed at the throat 114 and change the inlet area to maintain airflow speed under turbine load as close as possible to Mach=1 or any other designed value. By pushing the lower planar surface 108 upward by actuating the electrical actuator 270 which pushes its arm 272 leftward to push the bracket 276 leftward, which cause planar surface 108 to rotate around its hinge axis 260, thus decreasing the inlet area. To enlarge the inlet area, the actuator arm 272 retracts into its cylinder 270. All other elements in FIG. 7 having the same numbers are the same as in FIG. 1. The variable inlet area and the automatic control system are additional aspects of the invention. It should be noted that the control system could be monitored from far away control system by long distance communication either by phone lines or wireless communication. To enable this feature, a cellular modem and antenna are integrated with the control system CPU.

FIG. 8 is a front view of the air turbine of FIG. 7. Please note the location of the air speed measurement device 236 (Pitot tube) located in the bottom of chamber behind the throat plane 114, where the chamber's walls are parallel in order to arrange the flow 112 to have parallel streamlines.

FIG. 9 shows a top view section of the embodiment of FIG. 7. Note the direction of flow in chamber 220 where vertical guide vanes 116 are shown to arrange the flow in parallel lines.

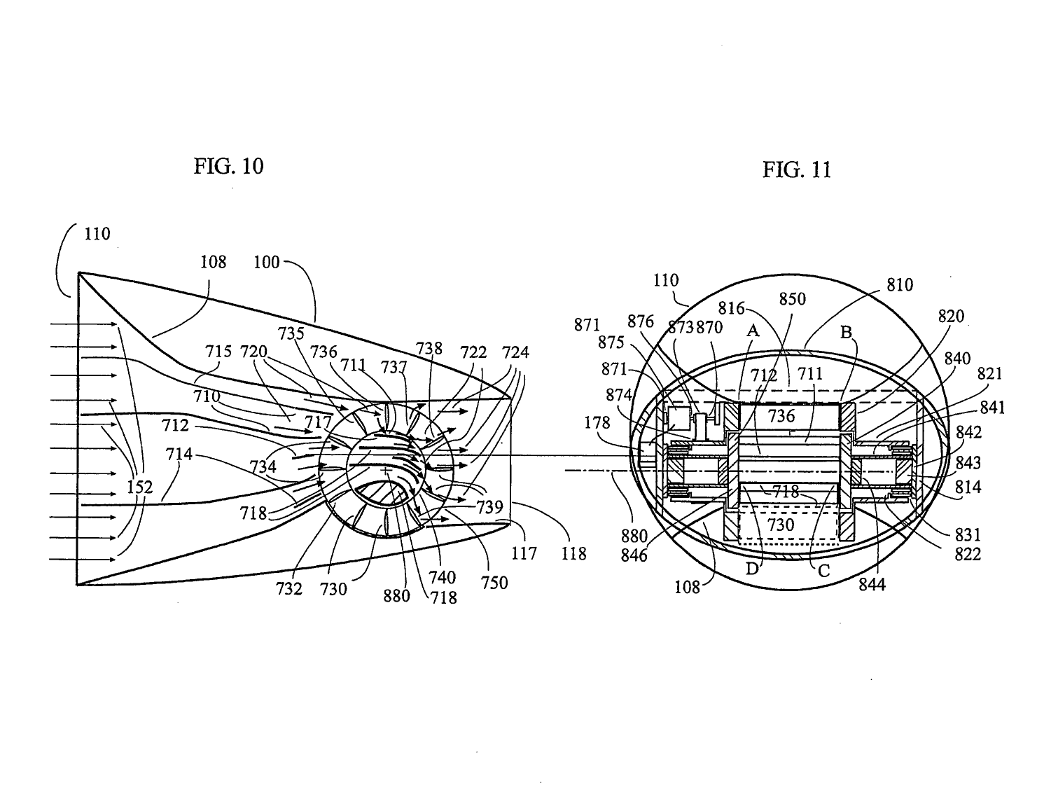

FIG. 10 is cross section made by vertical plane along the pod 100 centerline of another embodiment of the invention. As in the previous embodiments, the convergent nozzle is an important part of it. Here the rotor has about 12 wings, which their cross sections: 734, 736, 738 and 730 installed between two parallel rotate-able “rings” 820, 850 shown clearly in FIG. 11. Each wing side tip side edge is firmly connected to one of the rings 820, 850, thus when the wings are moved around axis 880 both rings rotate with them. Unlike former rotor design, here the wings' trailing edges are not attached to rotor' hub, thus the coming flow acts on these wing similarly as on aircraft wing. The rings rotation axis—880 in FIG. 11—is normal to the flow entering the inlet, as in the previous embodiments. The circle 740 shown in FIG. 10 is the inner contour of the rotating rings 820, 850, which can be seen clearly in FIG. 11. The guide vanes 716 are installed as shown and their side tips attached to the stator rings 840, 846. These guide vanes redirect flow leaving the rotate-able wings' trailing edges of wings 734, 735, 736, 737 to flow toward the wings at the right side of rings 820, 850 i.e., wings 738, 739, to further push these wings clockwise, to further exploit the kinetic energy from the flow, before it leaves the rotor area. Wing 736 is instantaneously normal to the flow 152. The static guide vanes 717,718 spans across the nozzle 108 width. These guide vanes directs the flow—arrows 720—to meet wings 734 at optimal angle of attack, i.e., each wing generate maximum torque around rotation axis 880 for each wing at its instantaneous location. Each wing torque comprises lift and drag components multiplied by the distance between the instantaneous resultant force to the rotation axis 880. At the center of rings 820, static guide vanes 717 and 718 spans across the nozzle throat, which is the nozzle cross section normal to the coming flow 152 at the location of wing 736. The throat is formed by nozzle sidewalls, which are seen in FIG. 11 and are as a matter of fact, the planar face of “rings” 820 and 840 at the right side and “ring 850 and 846 at the left side. The throat upper wall is the extension of the nozzle 108 upper wall while the lower wall is the top surface of a static body 718. This body prevents airflow to generate negative torque on the lower side wings 730, 732.

The wing in this embodiment have great advantages over propeller in free stream since the wing outward tips face the rings 820, 850 which serve as walls that prevent wing tip vortex, thus achieving high efficiency wing at low aspect ratio in the range of 1 to 5. Usually, propeller blades aspect ratio is in the range of about 10 or more to avoid lift loses due to wing tip vortex. Another advantage is that each wing is supported on both sides unlike propeller blade which is supported on one side only. This greatly enhances the wing rigidity. Yet another advantage in this design is the small radius of rotation, which decrease the centrifugal forces acting on the rotor, thus minimizing its weight and cost.

Another advantage in this embodiment is that drag forces are major contributors to the turbine driving torque. This can be seen for wings 735, 736, 737, 738.

Another advantage of this embodiment is that the throat is not block so that airflow can buildup in the nozzle so that the necessity of starting decreases compared to previous embodiment of this application.

Although the wings cross sections depicted in FIG. 10 have convention airplane profile, other profiles can serve this design even better. For example, wing profile with high camber (concave shape) or even symmetrical concave cross section having rounded wing leading and trailing edges.

Although the guide vanes 710,712,714 in FIG. 10 do not stretch along the entire nozzle length like in FIG. 1, FIG. 1's vanes are applicable here and in any convergent nozzle. This rotor embodiment can be used with combination of any nozzle of this application.

FIG. 11 shows a front view/section of the embodiment of FIG. 10. The ellipsoid 810 is a section normal to the flow 152 at the throat of the nozzle station. The nozzle itself is a rectangle depicted by its corner points A, B, C, and D. Wing 736 is clearly seen at the top of the throat. The wing side tips are connected to the ring 820 at the right side of the throat and its left tip is connected to ring 850. The rotor mechanism is symmetrical in this view, therefore only the right side will be explained. The ring 820 is a hollow disk with normal extension cylinder 821 that “seats” on bearing 824. The bearing 824 axis of rotation is 880. Disk 820 is made of any rigid and durable material such as steal.

Note the “shoulder 822, which limits the bearing 824 moving leftward. Bearing 824 “seats” on a static pipe 841, which its axis of symmetry coincides with the rotor axis 880. Disks 842, 843 and 844—preferably metal made—serve in connecting the pipe 841 to the stator disk 840 to the structure wall 814. Stator disk 840 has a symmetric left counterpart stator disk 846. Guide vanes 711 and 712 span across the throat width, i.e. between stator disks 840, 846. Each guide vane side edge is connected to either stator disks 840 or 846. This rotor design with its rotating wings, static guide vanes at the center of the rotor and the body, which prevents high-speed airflow from flowing toward wings at adverse position are additional aspect of the invention.

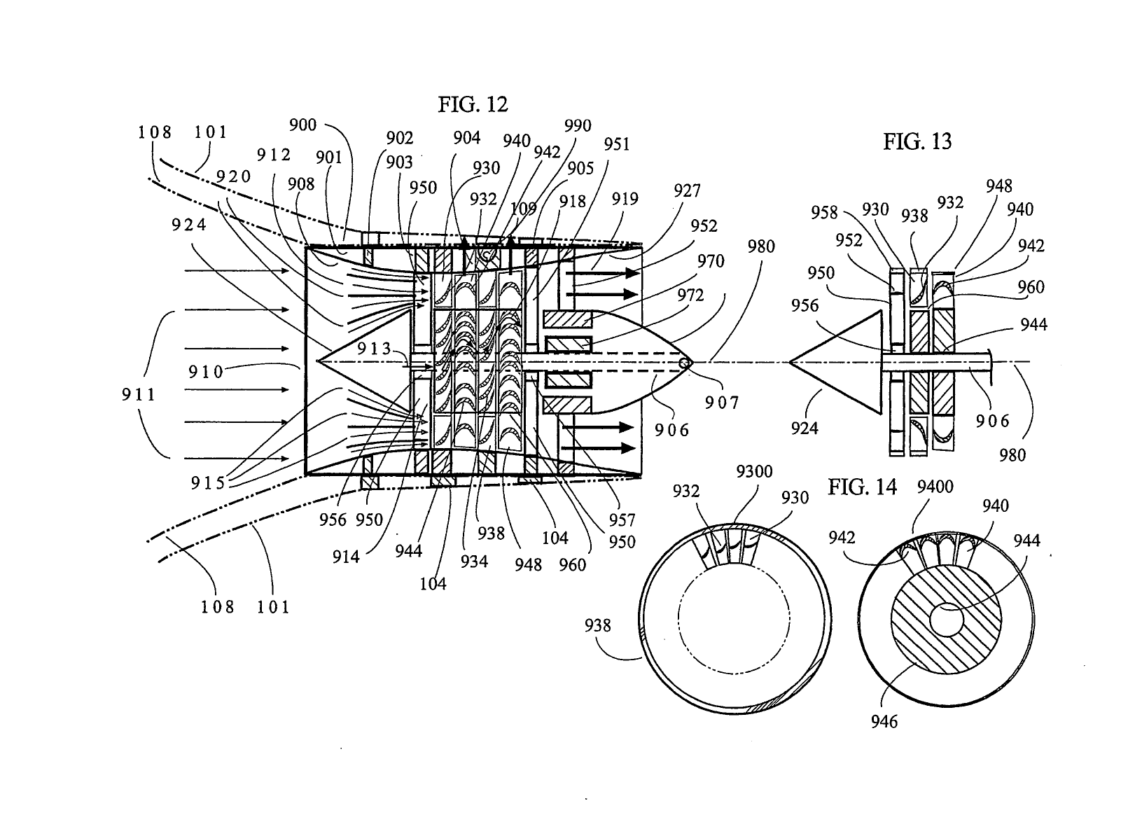

FIG. 12 is another embodiment of air-turbine to assembled to the throat area of a convergent nozzle having circular cross section. This is an axial flow turbine therefore most elements show in FIG. 12 are radially symmetrical as can see from FIG. 14 which show two typical elements. The phantom line 101 is the nozzle outer skin and phantom line 108 is the nozzle inner skin—as in FIGS. 1, 7 and 10. This is an axial flow turbine with arrangement for easy attachment to the convergent nozzle.

This novel design has several advantages. The first is better maintainability due to easy procedure of dismantling the turbine from its nozzle. The turbine is a machine with moving parts, which require periodic maintenance. The convergent nozzle has no moving parts therefore requires minimal maintenance. Thus to ease the maintenance task, the turbine unit can be easily dismantled and taken to a maintenance shop while a replacement unit is easily attached to the convergent nozzle which stays at its operating location. The unit is built very much like a turbojet engine. It comprises a pod 900 having internal frames 904, external skin 901 and internal skin 908. Guide vanes 920 are radially symmetrical to axis 980, wrapping cone 924 in 360°, direct the coming airflow 912, after leaving the nozzle exit and entering section 910, toward the turbine throat area 914. The airflow 912 reaches its maximum speed at the throat and arrives at the first row of stator guide vanes 930—known as “nozzles”—which wrap the rotating hub 960 but do not touch it—see the stator disk 9300 in FIG. 14 which comprises a plurality of guide vanes 930. Static guide vane 930 has a rectangle side view as seen in FIG. 12 has the cross section profile 932—seen also in FIGS. 13 and 14. The guide vane 930 is one of plurality of identical such vanes arranged in the same plane normal to axis 980 and together form the turbine first stage stator 9300 in FIG. 14. Element 934 is an illustrative representation of this plurality arranged next to same kind of representation of rotor blades 940. The rotor hub 960 is firmly attached to its shaft 906, which is supported through bearings 956, 957 and bars 950 to the pod outer structure frames 904, 905,906 by bars 950, 951. These bars are not radially symmetrical but simply symmetrical having four arms each as a cross, each arm has a wing profile cross sections—952 in FIG. 13—to minimize aerodynamic drag as they are static in the airflow.

Please note that bars can resist any longitudinal and side forces acting on the hub 960. The bearings 956, 957, allow the hub 960 to rotate freely around it longitudinal axis 980. The rotor disk 9400 (FIGS. 13 and 14) carries a plurality of blades 940. Blades 940 arranged at the circumference of the hub 960 as can be seen in FIG. 14.

Looking at the stator blade array representation 934 and its adjacent rotor blade array representation 944, which are depicted here to explain how the airflow moves from the stator vanes 930 to the rotor vanes 940, we can see that the stator blades 930 direct the flow 913 into best angle of attack towards the section profile 944 array so as to produce maximum aerodynamic force that pushes the rotator blades in the direction of arrow 990, i.e. rotation around axis 980. We can see that flow 913 changes its course by the stator profile to have best angle of attack when it meets rotor profile. The rotor profile in the banana shape Is useful in exploiting most of the kinetic energy from the flow. The flows moves like a snake around the stator and rotor sections causing the rotor to rotates in the 990 direction (around axis 980) and finally leaving as flow 918 which has small longitudinal speed component and small tangential speed component.

The rotor blade section 942 has symmetrical high camber aerodynamic profile, which is essential to take as much kinetic energy as possible from the driving flow. This arrangement of stator disks (nozzle) 930 and rotor disk 940 having cross sections 932, 942 respectively are known as “impulse turbine”. Impulse turbine is designed to maximize the energy taken from the flow. Since each turbine stage has limited capacity to extract kinetic energy from the flow, an optional additional impulse stage turbine 938,948 is added to the design.

Shaft 906 carries an electrical generator 970-972 and trailing edge cone 975, thus when the shaft rotates the generator rotor 972 rotates also but the generator stator 970 remains static as it is supported by bars 952 which is similar to bar 950. The electrical power is transferred by wire passing trough support 952.

The turbine pod frame 904 is located at the center of gravity of the turbine-generator unit thus a carrying hook 109 attached to the frame 904 is located at the center of gravity. When the unit is hoisted using hook 109, the unit is about to be in horizontal position to ease its introduction into the convergent nozzle rear entrance. After the unit is in its place, bolts are driven though nozzle frames 104 into the turbine frames 902, 903, 904, 905 to firmly attach the turbine to its convergent nozzle. The turbine rear cone has a hole 907 to help pulling the turbine unit from its nozzle.

FIG. 13 shows how the main turbine items are assembled. Cone 924 is connected to shaft 906 and then arm 950 is mounted on the bearing 956, which seats on the shaft 906. Then the hub disk 960 is firmly connected to the shaft, preferably by spline grooves. Then stator disk 9300 is put around the hub 960 and it will be connected later through its external ring 938 to the pod inner skin, so it will be a static element. Then the rotor disk 9400 is assembled on the shaft to firmly connected to it as the hub 960.

FIG. 14 shows plan-form view of stator disk 9300 and rotor disk 9400.

The use of axial air turbine unit, assembled similar to turbojet engine, in conjunction with convergent or convergent divergent nozzle is an aspect of the invention.

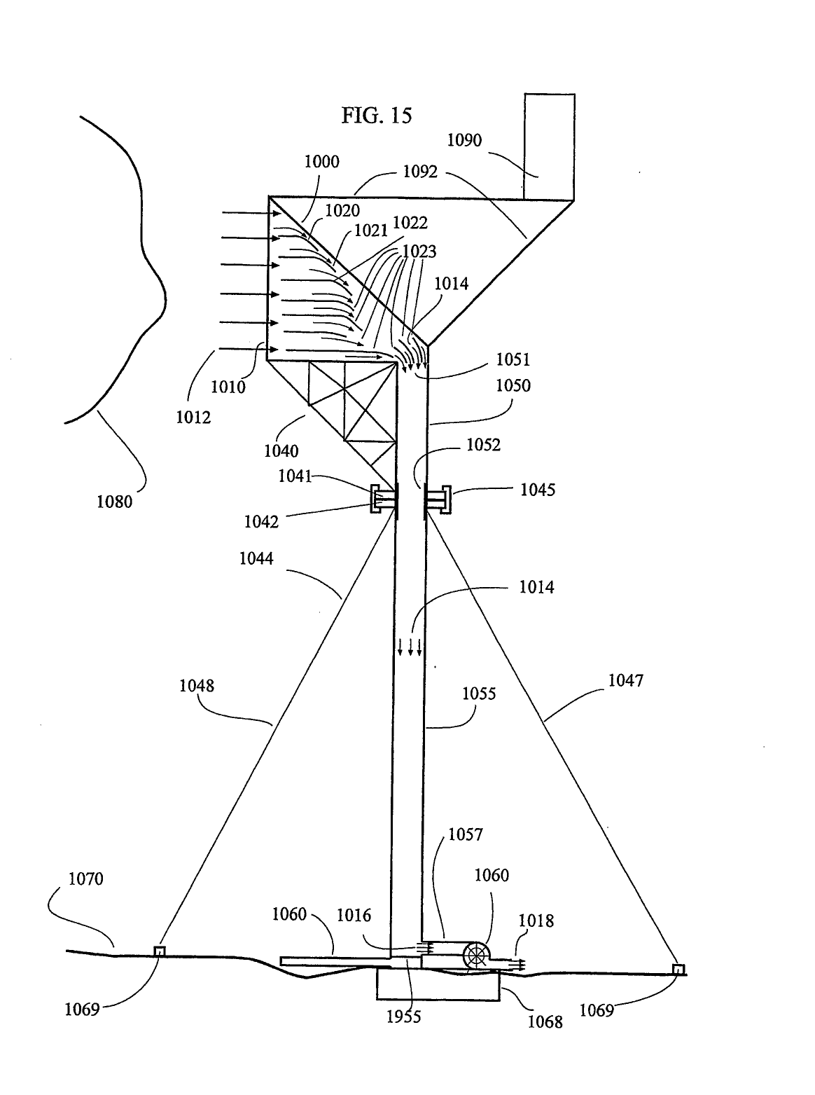

FIG. 15 shows another embodiment of the invention. A side view section of a convergent nozzle 1000 is mounted on a vertical pipe 1050, which could serve as a tower, which is secured to the ground by cables 1047, 1048 and basis 1068. Additional supporting cables acting in normal plane to cables 1047, 1048 are not shown. Thus the high structure (several hundred meters) is safely mounted. This design is good for any tower length starting from 1 meter and up. Air entering the convergent nozzle inlet 1010 is directed by guide vanes 1020 to 1023 and into the pipe top opening 1051. The airflow is pushed down the pipe as flow 1014 and through pipe 1057 as flow 1016 into any type of air turbine and especially to the embodiments described in this application. This embodiment (of FIG. 15) has three advantages: 1. The nozzle is placed high above the ground to catch higher speed wind; 2. There is no need to install the turbine unit on high tower where it is difficult, costly and hazardous to maintain; 3. The convergent nozzle by product is water. We realized that in the numerical solution given before, the natural air temperature decreased by 4° Rankin. This could bring a cloud 980 swallowed by the convergent nozzle to reach the temperature of liquidity which turns water vapors into water drops that flow inside the convergent nozzle into the pipes 1050, 1055 where at its bottom small holes will allow the water to flow into pipe 1065 and then collected in water reservoir (not shown). Thus in arid areas where water is in demand this embodiment could provide high quality water and electrical power. To direct the nozzle into the wind a vertical wing 1090 exert aerodynamic force through the structure 1092 that turns the nozzle into the wind. To allow this turn, a similar mechanism 130-140 as in FIG. 1 is employed. The pipe 1050 is rotate-able within pipe 1055. A bit smaller diameter pipe 1052 is firmly attached to pipe 1055 and extends into pipe 1050, where it serves as a shaft, around it, pipe 1050 rotates under the force of wing 1090. Disk 1041 is firmly attached to pipe 1050, lies on top of similar disk 1042, which is firmly attached to pipe 1055, so the top disk 1041 can slide on the bottom disk 1042. A clamp 1045 is attached from its lower side to the bottom disk 1042 thus it prevents the disk 1041 to move upward, thus keeping pipe 1050 and the entire nozzle assembly on top of pipe 1055 with the ability to rotate around a vertical axis running along the centerline of pipe 1050.

Thus, when aerodynamic force applies to vertical wing 1090, this force generates a rotating moment on the convergent nozzle assembly, forces the nozzle to turn until the aerodynamic force decreases to zero, i.e. the wing 1090 is inline with the wind direction and the inlet 1010 is facing the coming wind.

The embodiment of FIG. 15 is suitable for high power turbines that also aimed at water manufacturing. For example, we shall calculate the dimensions of 2 megawatts wind turbine. Using the data for wind speed of 21.737 FT/SEC:
P=F×V=>F=P/V=2,000,000/(221.9×0.3048)=29,570. Newtons=6,646.1 Lb
Therefore the nozzle throat area should be:
A=2×F/(ρV²C_{D})=2×6,646×(/(0.0023288×221.9²×1.0)=115.9 FT²=10.77 M²
Therefore, the nozzle inlet area should be 10 times bigger than the throat area, i.e. 10.77 M², i.e., an round inlet of 10.7 Meter, which is significantly smaller than the propeller based Vestas V80 turbine. Consequently, such a device of about 12 M tall by 27 M length will weigh and cost much less than the current technology propeller based wind turbine.
Please note that the Vestas V80 generates 2 Mega Watt from 15 M/SEC wind, which is much higher than the 6.6 M/SEC used here! Consequently the above turbine size at 15 M/sec could produce about 8 Mega Watt.
The embodiment of FIG. 15 is suitable for electrical power stations. There a big (inlet diameter of 20 to 100 meter or more) convergent nozzle could be used to generate hundreds of megawatts. Also, if water is required the nozzle could be mounted on mountain where clouds are close to ground, thus short pipe will suffice to catch clouds and turn them into water.

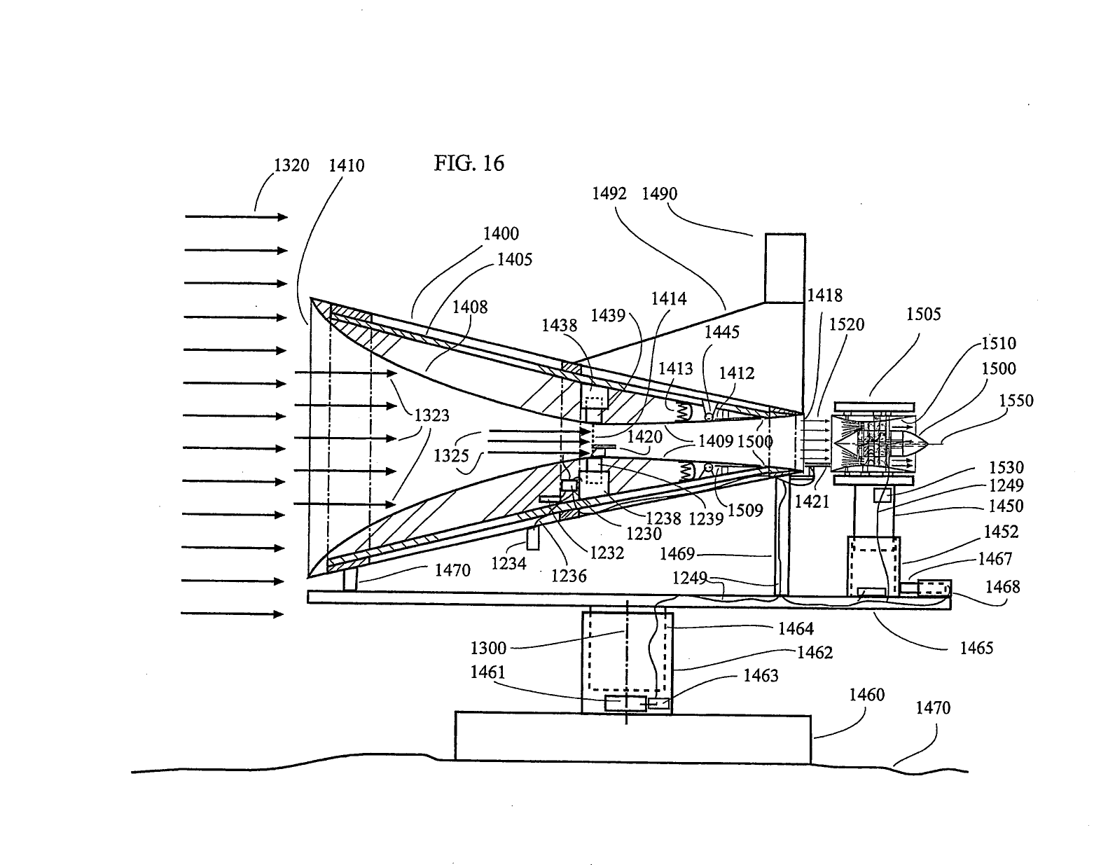

Since this invention is about conversion of air internal energy into kinetic energy it is desired to accelerate the airflow within the nozzle to maximum possible speed with maximum energy passing the throat. This speed is the speed of sound or slightly below. To achieve this speed a convergent divergent nozzle should be used. As was shown in the numerical case before, the Mach number at the nozzle entrance station 110 ((FIG. 1) and the area ratio between station 110 to station 114 (the throat) determines the throat area where speed of sound is attainable. Since Wind speed is not constant, another embodiment in FIG. 16 is presented, where automatic control system 1230 changes the throat area while the inlet area remains constant, with contrast to the embodiment of FIG. 7. The nozzle 1408 has a an inlet 1410 where the natural wind 1320 enters the nozzle 1408 which has a throat section 1414 and a slightly divergent nozzle from station 1414 to station 1418, where the flow 1520 exits the nozzle and enters the wind turbine 1500, which its axis of symmetry 1530 coincides with the nozzle longitudinal axis of symmetry. The control system memory stores data from table 2 of the reference book and standard and local atmospheric data such density, pressure temperature and speed of sound at various altitude values. Also, at least one Pitot tube 1420 is integrated to inform the control system CPU about the speed of airflow at the throat. Optionally another Pitot tube 1421 is installed to measure air speed of airflow 1520. The nozzle shown in this figure could have circular cross section or rectangular cross section. For a rectangular cross section an optional throat area control system is added in order to set the throat area at station 1414 so that the local airspeed at station 1414 reaches M=1., i.e. speed of sound, which is the maximum attainable air speed in this case.

The control system operates two electrical actuators 1238, 1438, each actuate a moveable push pistons 1239,1439. These push/pull pistons are attached to the nozzle inner skin 1408, 1409, thus, when these pistons move out from their cylinders 1238, 1438, they narrow the throat 1414, and vise versa. The Pitot tube 1420 measures the speed of the airflow 1325 at the throat and informs the control (digital computer) 1230 of that speed. The control unit by using its algorithm and stored data, determines whether to increase or decrease the throat area in order to achieve M=1.0 at the throat 1414. Since the Pitot tube 1420 continuously send air speed measurement, the control unit gets immediate feedback on airspeed after changing the throat area and to conclude how to improve the airflow speed.

The pistons 1239, 1439 push the skin 1408, 1409 (preferably steal made) against the puling devices 1413 which are spring based attachment that pull the skins 1409 toward the pod external frame thus enlarging the throat area 1414. The right side edges 1500 of the skins are free to slide on internal skins 1509, thus when the pistons 1239, 1439 moves to narrow the throat 1414, the skin edges 1500 moves leftward and vice versa. The control system comprises the control unit 1230, a battery 1232 and optional wireless transceiver connected to antenna 1234 (the control system is similar to a common cellular phone of year 2004). The control system uses control wire such as 1449 to send commands and to receive data coming from sensors such as the Pitot tubes. Another controlled system is the electrical stop/breaking system 1461, which stops the entire assembly from rotation around vertical axis 1300 due to aerodynamic wind forces exerted on the vertical wing 1490. The stop system is required to prevent sudden rotation of the entire assembly. This is important during maintenance, thus a stop command can be sent by a cellular phone. Alternatively a simple electrical switch can be installed in a safety distance so that a maintenance person activates this stop manually. The entire assembly is installed on one platform 1465 which has a rotate able vertical shaft 1464 inserted into cylinder 1462, where the electrical stop mechanism 1461 is installed. The cylinder 1462 is firmly connected to a basis 1460 lying on the ground 1470. The entire assembly could be located in the see on a tower or vessel and raised above the ground to any desired altitude. The platform 1465 carries the wind convergent divergent nozzle assembly 1400 on two columns 1469, 1470. The wind turbine unit 1500, similar to that of FIG. 12 is mounted on a column 1450 so that airflow exits the nozzle 1400, enters the turbine 1500 inlet. Optionally, the turbine unit 1500 is provided with starting system as described for the embodiment of FIG. 1.

Optionally the column 1450 height is controlled by the control system. The control unit 1230 controls column 1450 height in a similar method used for electrical actuators 1238, 1239. When wind is not present, the column 1450 is lowered thus no obstacle is found in the route of airflow 1520. When wind start to blow and steady state flow established in the nozzle 1408-1409, the control unit sends a command to raise wind turbine 1500 to its working position, as shown in the Figure. When the wind turbine is in the working position, the airflow 1520 enters the wind turbine inlet, hits the impulse turbine rotors, rotates them and the electrical generator assembled on the wind turbine rotation axis 1550, generates electricity. The electricity generated is then transferred to the grid and some of it charges a local battery 1530 and the control system battery 1232. An optional turbine starting system comprises of battery 1530 and the turbine integrated electrical generator/motor, which when driven by current from battery 1530 rotates the turbine rotor to reduce the resistance to the flow 1520. Thus when the wind-turbine 1500 is raised into position, its rotor is already rotating. When the wind-turbine is in its working position, the control system stops the starting process and the battery 1530 stops sending current to the motor/generator. An optional electrical actuator 1467, 1468 is provided to change the distance between the wind nozzle exit plane 1418 and the wind turbine inlet. This is done to minimize the inlet spillage and energy loss. An optional Pitot tube 1421 provides the control system feedback on the maximum attainable speed while an Ampere-meter/Voltmeter (not shown) provides important data on the electricity produced by the generator.

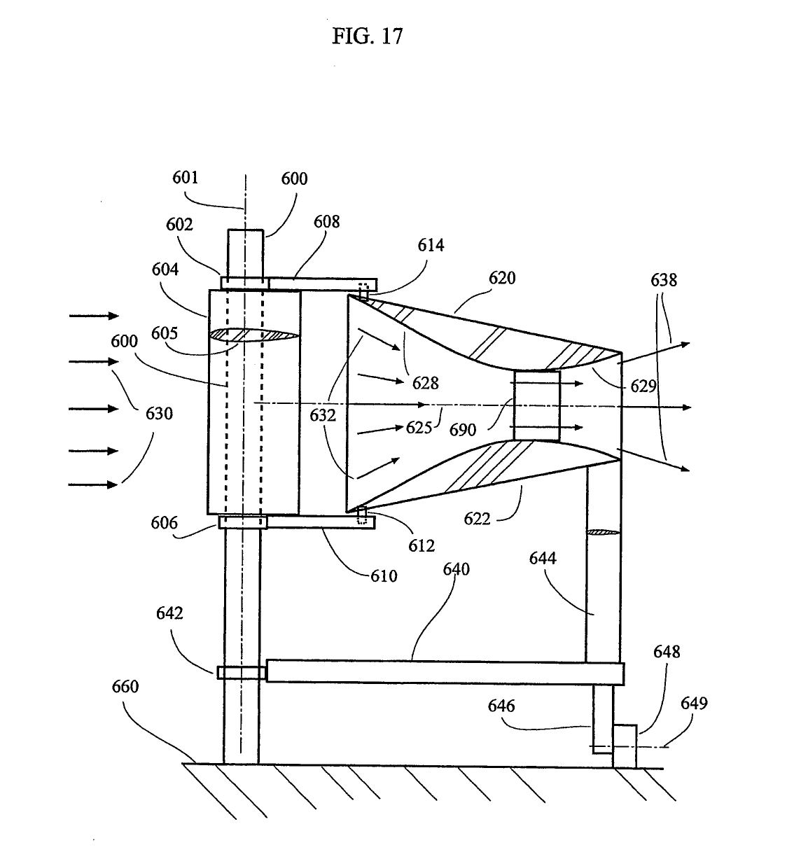

FIG. 17 schematically shows another embodiment of the invention. A vertical pipe 600, firmly attached to the ground 660, carrying 2 ring 602 and 606. These rings can rotate around pipe 600. Beam 608, 610 are firmly attached to rings 602, 604. The nozzle 620 is attached to beams 608, 610 through pins 612 and 614, thus the nozzle could optionally rotate around the pins' 612 614 vertical axis. This is important to reduce fatigue stress within the beams 608, 610.

The nozzle 620 carries within itself an air turbine 690, which is shown schematically to emphasize that any air turbine of these application or others designs could be installed in the nozzle. An optional carrying beam 640 is connected to the pipe 600 through ring 642. A vertical column 644 supports the rear end of the nozzle. The column 644 has a wing like profile cross section, thus it serves also as a stabilizer. An optional ground support column 644, has a wheel 648, which can rotate around its axis of rotation 649.

The rings 602, 606 optionally attached to a wing like fairing 600 having a cross section 605 as shown, to minimize air speed entering the nozzle inlet. When a wind 630 blows it rotates the nozzle to face the wind as shown because the nozzle lateral forces will rotate it around the pipe 600 vertical axis 601. Also, the optional column 644 acts as an airplane vertical stabilizer and helps in aligning the nozzle 600 into the wind. During such aligning, the wheel 649 rotates on the rigid surface 660. After the airflow 632 entered the nozzle 628, the flow arrives at the air turbine 690, rotates the turbine rotor and leaves the divergent nozzle 629 as airflow 638.

Advantages of this embodiment are: its natural stability and its ability to serve small—one meter inlet diameter—to large—100 meter inlet diameter—nozzles. Wind 630 pass by an optional wing fairing wing 604 and enters the nozzle as airflow 632. In the nozzle throat the turbine 690 converts the air kinetic into electricity. Note that the nozzle is a convergent-divergent nozzle to help stabilize the airflow within the nozzle.

All previous arrangement described with regard to previous embodiment are optionally valid for this embodiment also.

Further, the entire installation of nozzle 600 and its support mechanism 602-649 could be provided with means that shortens the pipe 600 (and the optional column 644) so that the nozzle is lowered. A protecting wall around the entire embodiment—not shown—could block strong winds from attacking and damaging the wind-turbine.

Also, such embodiment can be installed at sea where the wheel 649 is replaced by boat or buoy

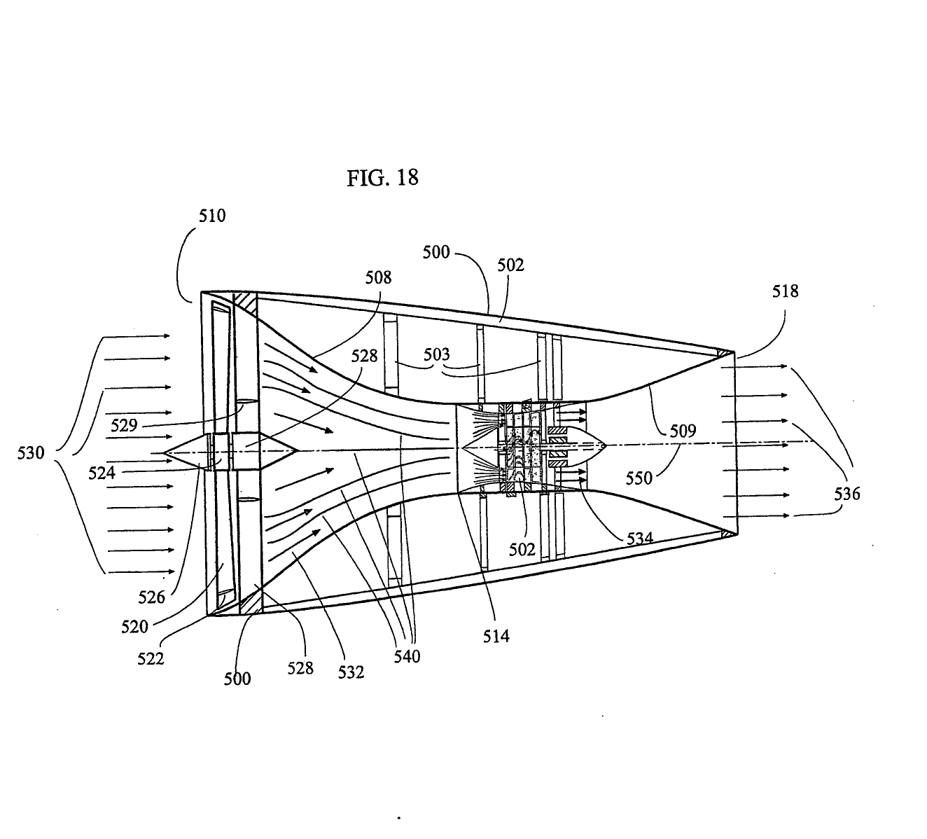

FIG. 18 shows another embodiment of the invention. It was proved with regard to FIG. 1 that the convergent nozzle converts some of the air internal energy into kinetic energy provided that air flows from the large area inlet toward a smaller area cross section—see page 16 of this application. To make this invention independent of wind power, it is worthwhile to generate artificial airflow, since the convergent nozzle is able to increase the airflow kinetic energy by converting the air internal energy into kinetic energy. It was shown that the amount of internal energy converted to kinetic energy was: 221.9²/−21.737²=104.2 times the natural (wind) kinetic energy. Therefore, another embodiment of the invention consists of a powered fan 520 positioned in the nozzle inlet as shown in FIG. 18, generates airflow 530 toward the throat 514 where an air-turbine 502 is positioned. The air turbine is the one that is shown in FIG. 12 of this application however other air turbine could be used. The turbine 502 depicted in FIG. 18 shows a mechanical power output system that takes some of the turbine power and transfers it via gear 552 engaged with gear 562 to a shaft 560 which transfers a rotation power to a gearbox 568 and to any rotation power consumer via shaft 569. Such arrangement is an engine for driving a vehicle. To start the turbine/engine, the driver connects the powered fan 520 electrical motor 528 to a battery (not shown). The fan 520 sucks air 530 into the convergent nozzle, where the airflow accelerates and arrives at the turbine 502. Turbine 502 here includes electrical generator, which is not shown mounted on shaft 551 as shown in FIG. 12.

The powered fan 520, preferably driven by electrical motor 528, however any external power can be used. For example, a power shaft (PTO), driven by any external power, connected to the fan hub 526 could drive the fan. The fan sucks air 530 and it as pushes airflow 532 toward the throat 514. The fan support beams 528 have a wing profile cross-section 529 to minimize drag and to direct the flow along the axis of symmetry. Optional guide vanes 540—preferable aluminum or stainless steal, are stretched across the nozzle width keep the flow without separation and minimize turbulence and pressure rise. The guide vanes can be thin planar metal sheets or circular metal sheets built symmetrically around the nozzle axis of symmetry 550. An important aspect of these guide vanes (applicable for all nozzles in this application) is that the guide vanes downstream edges slopes are parallel to each other and to the nozzle axis of symmetry 550. This is important to prevent turbulence and to assure smooth combination of all the sub-streams emerges between the guide vanes.

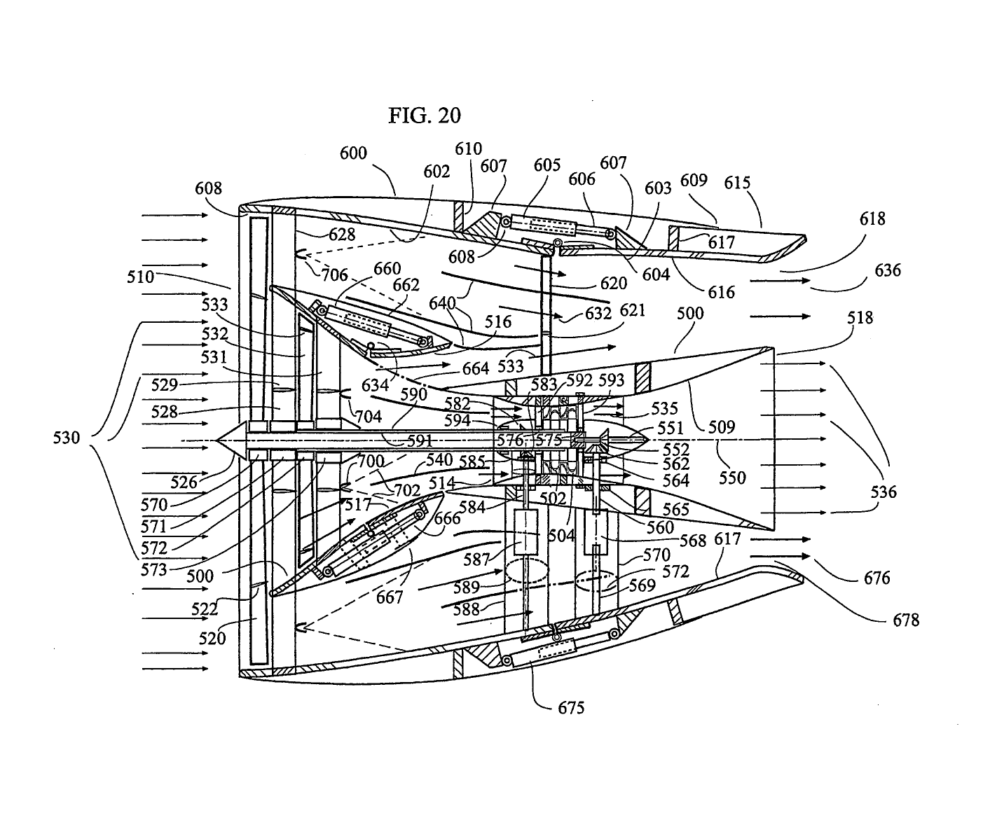

Furthermore, the turbine shaft extended to carry the fan as it seen in FIG. 20 can power the fan.

Assuming a fan driven by electrical motor 528 having a nominal power of X Kilo-Watt. Further, assuming that the fan transfers 50% of the electrical power into kinetic energy and that the nozzle is only 80% isentropic due to turbulence and separation. Thus the steady state flow enters the inlet 510, has only about 30% X of the electrical energy invested by the electrical motor 528. However, in the throat, the kinetic energy could be increased 100 times (assuming throat area 1/10 of the inlet 510 area, thanks to the convergent nozzle action we get kinetic energy in the throat, which is 30×, i.e. 30 times more than the energy invested. If turbine 502 is 50% efficient, it provides 15× power and the net profit is 14× power. Thus we get an independent energy machine that generates more energy that it consumes all on the expense of air internal source of internal energy. The pod 500 is built like a turbojet engine pod with longitudinal beams 502 and frames 503, which support the internal skin 508 509 and the pod external skin. All installing arrangements mentioned for the embodiment of FIG. 1 to 17 are applicable here. It should be noted that this embodiment could run on wind power also with or without engine 508 power. In case this device is operated on natural wind, the alignment vertical tail wing is required. Also, note the sharp inlet leading edge, which is different from the typical rounded leading edges found in turbojet engines pods. The implementation of powered fan in the inlet could be used as home power station, public power stations that provide electrical power to the electrical grid and automobile engines. As for public power stations, since they already have steam facilities, the steam power could be used to drive the powered fan while the electrical generator provides electrical power to the grid.

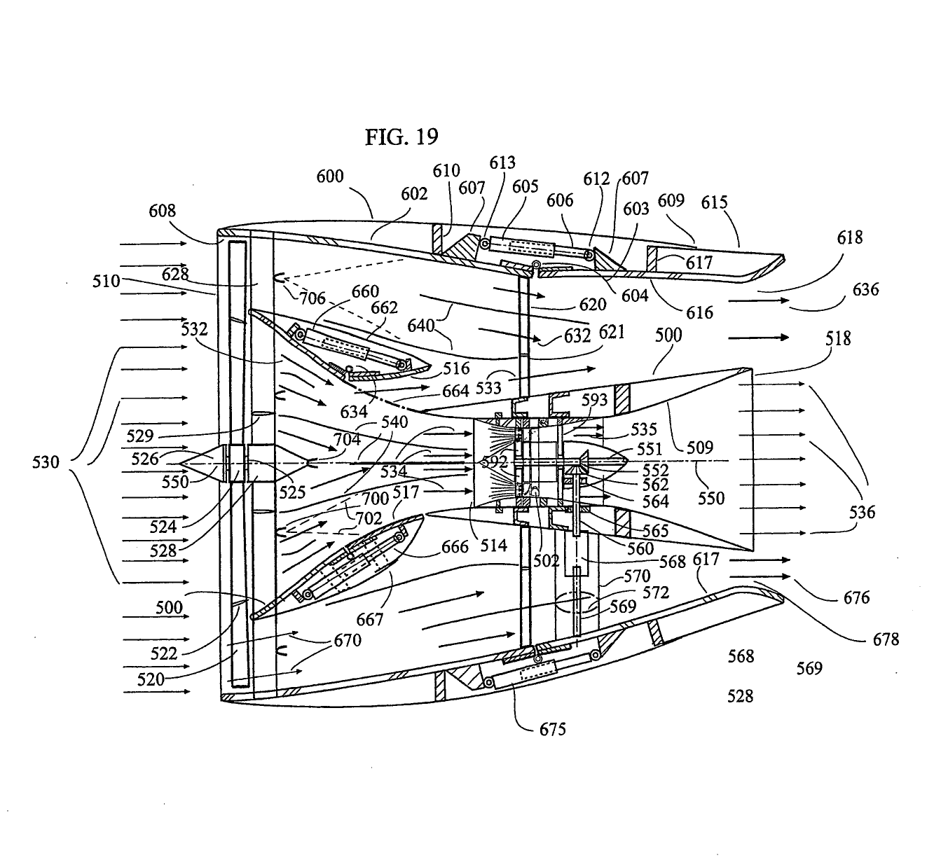

FIG. 19 is yet another embodiment of the invention where convergent or convergent-divergent nozzles combined with a powered fan a turbine serves as a turbo-prop engine to drive an aircraft. FIG. 19 is a side view/section along the axis of symmetry 550 of the pod, nozzles and fan, all of them are radially symmetrical to axis 550. At the inlet of 500 and 608 a fan 520 is mounted on a shaft 525, which its axis of rotation coincides with axis 550. An electrical motor 528 rotates shaft 525 thus rotating the fan 520, which while rotating suck air 530 that flows into said nozzles. Further down stream arrows 532 represent the flow within nozzle 500 after passing the static wing 628 which its cross section 529 directs the airflow to flow parallel to axis 550. Also guide vanes 540 (also known as splitter vanes) prevent turbulence and create sub convergent nozzles that direct the airflow 534 toward the turbine Inlet 514. As the airflow reach its top speed at the turbine throat it rotate the turbine rotor 502 mounted on shaft 551 and force it to rotate and to drive a bevel gear 552 engaged with bevel gear 562 which is mounted on a shaft 560 that enters an electrical generator 568 which generates electrical power to drive the fan 520 after the engine has been started by using external power source as a battery or other source. Fan 520 throws air to both nozzles 500 and 608. The outer part of fan 520 throws airflow 570 through guide vanes 640. This air is accelerated or decelerated by changing the nozzle cross-section areas by moving its moveable wall 603 inward or outward, to generate the maximum thrust as it leaves the exhaust section 618. Nozzle wall 603 has a shape of rectangle cutout from a cylinder. Several such part around the nozzle circumference enable the change of the nozzle throat. Wall 603 is therefore moveable and connected to the pod 600 by the hinge 604 and the electrical actuator 606 mounting element 609. Electrical actuator 606 other end is mounted actuator arm 606 retracts into is cylinder 605, it force element 612 to move leftward and to rotate anticlockwise around the hinge line of hinge 604, thus increasing the nozzle cross section. Alternatively, the actuator 605-606 can be hydraulic actuator. The bottom half of FIG. 19 shows the engine where both nozzles are at their normal position. Frame 610 stiffen the pod 600 and firmly connected to the outer pod skin 609, which is elastic material pushed against skin 615 of the moveable door 616, thus when door 616 is moved, skin 519 remain in contact with it. Beams 620 are plurality of radially distributed support beams having a wing profile cross section 621, connect the inner nozzle which contains the turbine to the external pod inner skin 602.

To start the engine, electrical current is provided from a battery or other source to the electrical motor 528, which drives the fan shaft 525.

Since aircraft engines required to operate in a wide range of airspeed, from zero speed at takeoff to maximum speed at cruise, the theoretical throat area of a convergent divergent nozzle, which brings the airflow close to Mach=1.0, vary according to inlet speed. Thus, if the engine design point is the take-off speed, then, when the aircraft gains speed, the nozzle throat area require to be increased, otherwise the flow could become chalked, i.e., Mach=1 will be achieved at the throat but the airflow mass rate will not increased. To avoid this chalk, the inner nozzle wall 516 is moveable and shown in the increased cross section area position while its close position is shown in 607. This variable geometry nozzle is another aspect of the invention.

To increase this engine thrust, optional fuel injectors 700, 704 and 706 are provided. Such fuel injectors are radially distributed across the nozzles cross sections (there are several wings 628 radially distributed that guide the airflow and are not shown, each of these optionally carry these fuel injectors. The lines 702 depict a cone where the burning fuel flame propagates. Such a fuel injection is required especially in high altitude cruise (above 20,000 FT) and could be used for takeoff purposes since this engine thrust depends on the airflow speed in the inlet.

FIG. 19 shows that the fan is driven by electrical motor 528. However, the fan could be driven by a shaft connecting the turbine rotor 502 to the fan 520, thus eliminating the need of large power electrical motor 528. Such a solution is shown in FIG. 20.

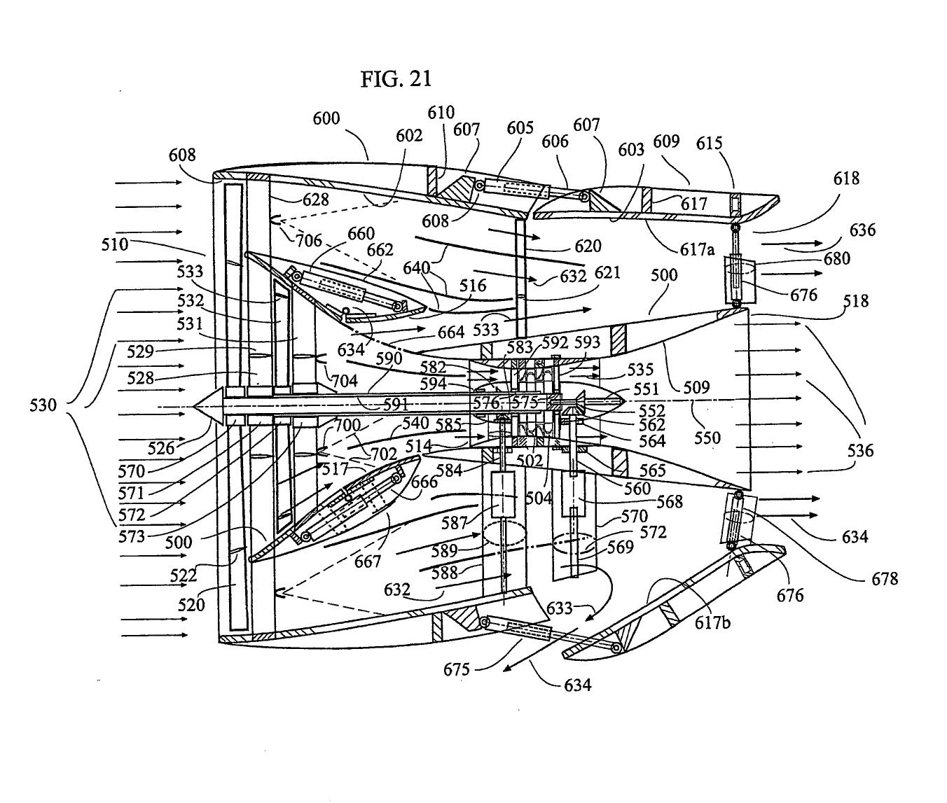

A control system, similar to that described for the previous embodiments (not shown in FIG. 19) is used to control the excess airflow doors 516, 616 in both embodiments of FIGS. 19 and 20. To control engines thrust, a direct current opposite in direction to the engine starting power is provided to the electrical motor 528. Changing the electrical current generated by the electrical generator (DC current) is by changing the connections of the wires connecting the output of electrical generator 568 with the wires going to the electrical motor 528. Alternatively, the moveable doors 616 are moved to close the outer nozzle 602 exit area. A thrust reverser is shown in FIG. 21.

To demonstrate the ability of such engine to serve as an aircraft engine, we shall calculate the thrust and power of such engine having an inlet area of 0.5 M² at sea level, aircraft speed V_{AC}=0, airflow at the central nozzle inlet V=34 M/Sec=111.5 Ft/Sec. Standard atmosphere: T=59+460=519° R; ρ=0.002378; p=2116.2 LB/Ft²; a=1117 Ft/Sec
1. Calculating the mass flow rate m through the central nozzle:
   m=ρ×V×A=0.002378×34/(0.3048)×0.5×10.76=1.427 Slug/Sec
2. Calculating the energy per second required to push static air into V=34 Ft/See (inlet)
   E_{K}=0.5 dm/dt×V²=0.5×1.427×(34/0.3048)²=8,878.1 Ft×Lb
3. Calculating the throat cross section area using table 2 of the Ref. Book, for
   Mach=0.1: A*/A^{I}=0.1718=>A*=A_{I}×0.1718=0.5×0.1718=0.0859 M²=0.092 Ft²
4. Calculating the energy per second at the throat assuming Mach=1, i.e. V=1117 Ft/Sec:
   E_{K}=0.5 dm/dt×V²=0.5×1.427×(1117)2=890,226.1 Ft×Lb
5. Assuming turbine efficiency of 45% then the available energy to drive the propeller is: 0.45×890,226=400,601.7 Ft×Lb/Sec=542,783. Watt/Sec=723.7 HP.
6. Calculating the engine power at aircraft speed of 185 Ft/Sec we assume the fan at this speed pushes the air at about 223.4 Ft/Sec which is Mach=0.2.
   From table 2 of the Ref. Book we get A*/A=0.3374=>A*=0.5×0.3374=0.1687 M².
   This throat area is larger than the throat area calculated in Parag. 3 for V=34 M/sec=111.5 Ft/Sec.
   Therefore, the smaller throat could become chalked now and to prevent this the door 516 in FIG. 19 is opened to let excess flow to bypass the turbine as flow 533 and joins the flow 632 that enters the external nozzle. Both flows are driven by the power supplied by the turbine as calculated in Parag. 5.

To increase the engine power, jet fuel could be injected. The burning fuel will increase the pressure in the nozzle and increase the Mach number at the turbine since the speed of sound is proportional to the square root of the temperature. Thus if the temperature of the gas in the turbine would be increased to 1000° R the speed of sound would be √(γRT)=√(1.4×1715×1000)=1549.5 1.387 more than the speed of sound of air standard atmosphere at sea level. This speed of sound increment means 1.387³=2.67 times increase of turbine power.

Another option to increase the engine power is to design it for aircraft speed which is about the rotation speed, i.e, about Mach=0.15. Assuming that airflow speed at the inlet 510 would be Mach=0.2, i.e:
A*/A=0.3374=>A*=0.5×0.3374=0.1687 M².
7. The airflow stagnation parameters at the inlet 510 before the air enters the inlet are:
   T₀=T+V2/2CP=59+460+(0.×1117)²/12000=519° R
   ρ₀=ρ(T₀/T)^{(1/γ-1)}=0.002378×(519/519.)^{2.5}
   ρ₀=0.002378 Slug/Ft³
   ρ₀=ρ₀RT₀=0.002378×1715×519=2116.3 Lb/Ft².
8. Calculating the rate of mass flown mat the inlet 510:
   Assuming isentropic air acceleration from M=0 to M=0.2 we find p from table 2:
      [ρ/ρ₀]M=0.2=0.9803=>ρ=0.9803×0.002378=0.002331 Slug/Ft³
      m=ρVA=0.002331×0.2×1117×(0.5×10.76)=2.80 Slug/Sec
9. Calculating the air kinetic energy at the turbine throat, assuming M=1:
   1) calculating the static temperature at the throat, from table we get:
      T/T0=0.8333=>T=0.8333×519=432.48° R
   2) calculating the speed of sound:
      a/a₀=0.9129=>0.9129×1117=1019.7 Ft/Sec
   3) the airflow speed at the throat is: V=a×1.0=1019.7
      E_{K}]ₜₕᵣₒₐₜ=0.5×m×V²=0.5×2.80×(1019.7)2=1,455,703.3 Ft×Lb
      Comparing this value to the value calculated at Parag. 4 we get significant increase of 1,455,703/890,226=1.63.
      Assuming 45% of this energy can be used we get 0.45×1,455,703=655,066 Ft×Lb
10. Calculating the energy per second required to push airflow speed from M=0.15 to M=0.2 in by the propeller:
   E_{K}=E_{K}]_{M=0.2}−E_{K}]_{M=0.15}=0.5×m×[V]_{M=0.2})²−(V]_{M=0.15})²]=0.5×2.80×[(0.2×1117)²−(0.15×1117)²]=30,568.4 Ft×Lb
11. The net energy per second available to the prop is:
   655,066−30,568=624,498 Ft×Lb=846,146 Watt/Sec=1128 HP.

By designing the engine for M=1 at aircraft speed of M=0.15 and M=1.0 at the turbine throat we need bigger turbine that has throat area of A=0.1687 M² and the engine power at aircraft speed V=0 will be lower since we the airflow speed at the throat would be less than 1.0

Naturally current fuel power turboprop engine of the size used here generates about 3000 HP but one should remember that they used a lot of fuel, which is significant part of common aircraft takeoff weight, i.e, about 25% for an aircraft such as ATR42-400.

Therefore, the engine according to this invention are:
1. The engine do not use fuel, meaning that the aircraft flight range is unlimited.
2. The aircraft is safer—no fire hazard.
3. The aircraft needs no fuel tank and fuel systems, therefore lighter and cheaper to build, so its operating cost is smaller.
4. The aircraft is much quieter since burning fuel generates much of the engine noise.
5. The aircraft do not generates CO₂ and do not contribute to earth warming process, on the contrary, it lowers the air temperature thus this engine is highly environmental.

FIG. 20 shows another embodiment of an engine using the invention. This is another turboprop engine for aircraft having similar nozzles designs. This engine has two coaxial drive shafts. The inner drive shaft 591 connects the turbine low air speed rotor 504 with the large fan 520 while drive shaft 590 connects the high air speed rotor 502 to the smaller inner fan 532. To start this engine, electrical current is provided to the electrical motor 587 that through shaft 584 drives bevel gears set 583-582. Gear 582 is firmly connected to the outer shaft 590 that drives the smaller fan 532. As the fan 532 rotates, it sucks air 530 that enters the inner nozzle 500 passing the large fan 520 and static wings 528 (only one is shown in this view). Note that wings 528 support the inner shaft 591 through bearing 571. Shaft 591 is supported at the turbine side by arms 593 and bearing 575. Similarly, outer shaft 590 is supported by static wings 531 (only one is shown in this view) through bearing 573 and the other end is supported by arms 592 and bearing 576. The static wings 528 and 531 redirect the airflow generated by the fans to flow parallel to the engine axis 550. After the airflow passes the static guide/support wing 531 it is directed toward the turbine inlet by the guide vane (also known as splitter vane) 540, which is radially symmetrical to axis 550. This vane is an optional element to maintain isentropic flow in the nozzle and to prevent turbulence. When the airflow enters the turbine at high speed since after being accelerated by the convergent nozzle 500, it rotates the turbine rotor 502 and afterwards rotates turbine rotor 504. Rotor 504 is designed to exploit most of the air kinetic energy of the airflow passing through the turbine. After the air leaves the turbine rotor as flow 535 it is expanded in the divergent nozzle 509 and exit the turbine as flow 536. The rotor 504 rotates the inner shaft 591 that rotates the large fan 520, firmly connected to the shaft 591 through its hub 570. This fan is the major thrust generator of this engine. The fan 520 pushes airflow to both nozzles 500 and 608. To prevent excess air in the inner nozzle, door 516 is opened (see explanation for FIG. 19) and this airflow 533 enters the outer nozzle and joins airflow 632, which enters the outer nozzle 608. Note that optional guide vanes (radially symmetrical to axis 550) help in keeping the airflow without turbulence. Optionally (not shown in the Fig.) additional guiding vanes stem radially from the axis outward helps prevent the swirl movement of the flow due to the fan movement.

A control system, similar to that described for the previous embodiments (not shown in FIGS. 19 and 20) is used to control the excess airflow doors 516 616 in both embodiments of FIGS. 19 and 20. To control engines thrust, a brake within the case 568 is operated to control the large fan 520 number of RPM, thus changing the engine thrust.

FIG. 21 shows another embodiment of a turboprop engine according to the invention. Basically it is the same engine depicted in FIG. 20 however it has a thrust reverser 616. The outer nozzle rear element 616a is at aircraft cruise position. It is connected to pod 600 by two electrical actuators 605 and 676. During landing when large braking force is required the pilot operates the thrust reverser, i.e. actuator 676 retracts fully as seen on the other half of the drawing as 678, while the actuator 605 is now fully extended as 675. The result of this mutual action is the new position of door 616a seen as 617b. The position of 617b decreases the nozzle exhaust area and some of the flow turns as 633 and 634 thus creates a braking force. It should be understood that the engine pod comprises of several such doors all operated simultaneously. Also note that the shaft coming from the electrical motor 568 is not “floating” after it's mounting, i.e., the movable door 617b has been moved. The actual mounting is between such moveable doors 616 where there are unmovable parts of the nozzle and the shaft is mounted on one of these unmovable parts.

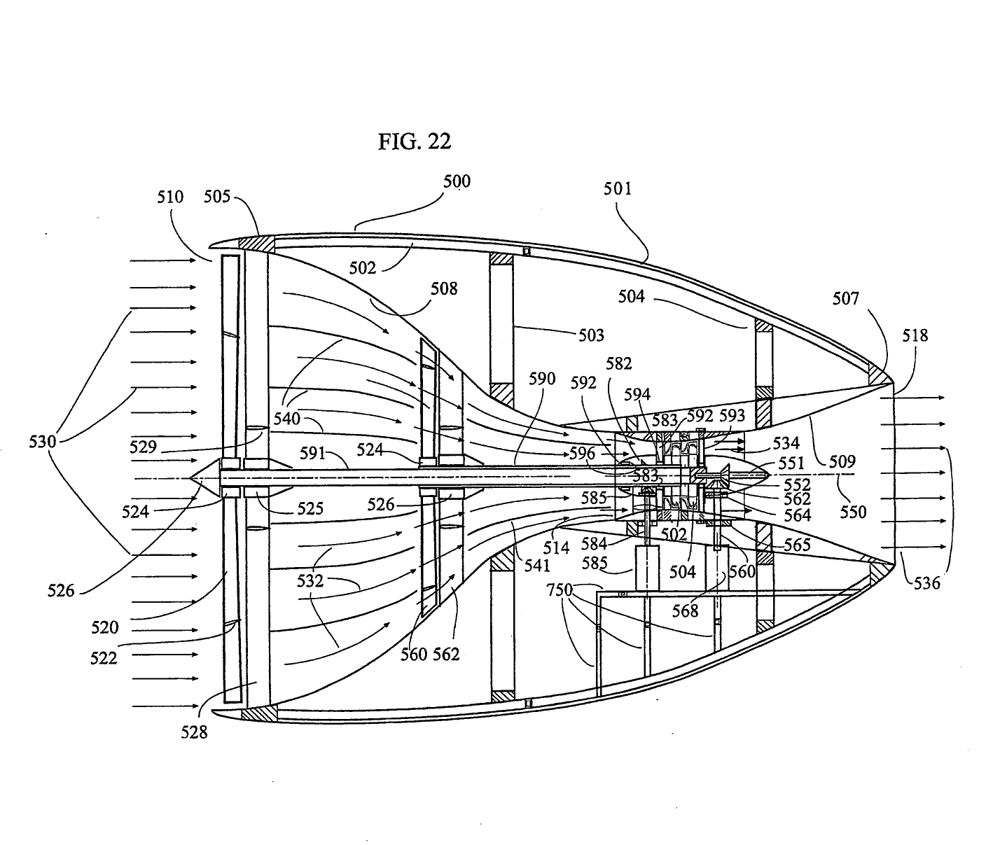

FIG. 22 is another embodiment according to the invention. This embodiment produces electricity out of airflow in the convergent nozzle. This embodiment uses the same technology of a turboprop engine similar to the embodiments of FIGS. 19 and 20. The smaller fan 532 is started by external power source that drives the outer shaft 590. Such a source could be an electrical battery, or other electrical power supply that drives electrical motor 585 which rotates a shaft 584 which through bevel gears 582-583 drives the outer shaft 590, which causes the smaller fan 560 to rotate and sucks air 530 into the nozzle 500. As the flow 532 accelerates toward the fan 560 due to the convergent nozzle, it passes the fan 560 and the support beams 562, which have wing's profile cross sections. The support wings 562 supports the outer shaft 590 through bearing 526. There are several support elements 562 distributed radially around the turbine axis of symmetry 550 and they serve also to direct the flow and eliminate the rotational flow speed from the fan 560. Note the optional guide vanes 540 and 541 that help in keeping the flow without turbulence. These guide vanes are radially symmetrical to the axis of symmetry 550. The airflow is entering the turbine at a speed near the speed of sound and rotates the turbine's rotors 502 and 504. rotor 502 drives the outer shaft 590 which rotates the smaller fan 560, while the rotor 504 drives the inner shaft 591 that drives the larger fan 520. As rotor 504 gets a larger part of the turbine kinetic energy (by having high efficiency turbine blade profiles) it uses the most of the air kinetic energy for two consumers: first, the large fan 520 and second to drive the electrical generator 568 through bevel gears 552-562 and shaft 560. Thus, large amount of air is now pushed into the turbine and a significant amount of power produced by rotor 504 is delivered to the electrical generator 568. The generated electrical current is transferred to consumers or to the public grid.

The advantage of the embodiment of FIG. 22 over the embodiment of FIG. 18 is that the smaller fan 560 requires small amount of power to start rotating fan 560. After fan 560 starts the sucking, the turbine provides the power to drive the large fan 520. For example, a private home device could use a small 50 CM fan diameter while the larger fan diameter is about 1 meters to provide about 7 kilowatt electrical power. It should be noted that the shafts connecting the turbine rotors could be replaced by electrical motors directly driving the device fans so that electricity generated by the generator 585 drives electrical motor (not show in FIG. 22 but shown in FIG. 18 as element 528). This electrical motor shaft serves as the fan shaft as well, as it is shown in FIG. 18. The same is applied to fan 520, which is optionally driven by an electrical motor (not shown in FIG. 22) which gets electricity from generator 568.

It should be noted that any combination of any nozzle design and air turbine design with or without powered fan could be made according to this invention. Thus the convergent divergent nozzle of FIG. 16 can be combined with any air-turbine described in this application. Also any system described with regard to one embodiment of the invention is relevant to other embodiments described here where it is practical and these cases are also part of the invention. For example, the starting systems are relevant to all wind turbine embodiments. Other examples are the use of optional control systems, Pitot airspeed measuring device, any movement sensors and stop systems described with regard to FIG. 14. Moreover, Conventional “propeller” like wind turbines one or even several one after the other could be installed at throat of the convergent nozzle or at a small distance behind the exit nozzle as demonstrated in FIG. 16.

As we realized from the numerical calculation, air flowing through the convergent nozzle is chilled, therefore, ice could be accumulated in the nozzle and on the turbine's rotor blades. One method to prevent ice accumulation is by spraying nozzle elements and turbine elements surfaces with ice repelling liquids like oils or kerosene before and during operation. Another method is to warm these surfaces by electrical current or by hot air, produced by electrical heater could be used to melt ice from important locations. Preventing ice accumulation is another aspect of the invention.

It will be appreciated that the invention is not limited to what has been described hereinabove merely by way of example. Rather, the invention is limited solely by the claims, which follow.

1. A method for converting air internal energy into kinetic energy and further converting kinetic energy into mechanical energy.

2. A method of claim 1 is made by making air to flow through a nozzle having an inlet cross section area Aᵢ, temperature Tᵢ and speed Vᵢ while downstream, airflow parameters at variable cross sections areas are: area A_{d}, speed V_{d} and temperature T_{d}, where part or all of said cross sections A_{d} are smaller than Aᵢ, so that airspeed value V_{d} at A_{d} is greater than Vᵢ by about the product of: Vᵢ multiplied by the ratio: Aᵢ divided by A_{d} (Aᵢ/A_{d}), where increment of airspeed kinetic energy due to the increment of airspeed V_{d}, is about the equivalent of the decrement of air internal energy, i.e., airflow mass rate m multiplied by air constant pressure specific heat C_{P} and further multiplied by the decrement of air temperature ΔT at section A_{d}, i.e., ΔT=Tⱼ−T_{d}, thus this energy conversion is about: m*C_{P}*ΔT which is about equal to:
m*(V_{d}²−Vᵢ²)/2.

3. A method according to claim 2 where a turbine is positioned either in the nozzle exit or within the nozzle to convert some of the air kinetic energy into mechanical energy.

4. A method according to claim 2, where said nozzle have continuously smaller cross sections to continuously accelerate airspeed.

5. A method according to 2 where said nozzle is convergent-divergent nozzle and a turbine is positioned at the nozzle minimum cross section area, i.e., the throat, or at a section having bigger cross section area either before the throat cross section or after the throat cross section.

6. A device according to claim 2 having inside its nozzle at least one guide vane that forms at least two sub-streams flowing through variable cross section areas.

7. A nozzle according to claim 1 having inside it plurality of guide vanes.

8. A device according to claim 2 where the air contains moisture, thus as the air accelerates and its temperature decreases, the moisture condensates and turns into water droplets thus static air pressure in the nozzle decreases and forms additional suction force that increase the speed and mass flow entering the nozzle.

9. A device according to claim 8 where the water droplets are accumulated to be use for any usage.

10. A device according to claim 5 where said turbine provide mechanical energy to drive an electrical generator that generates electricity or to provide a mechanical energy to serve as an engine.

11. A device according to claim 2 where the airflow's source is natural wind.

12. A wind turbine attached to nozzle according to claim 2, having a rotor hub rotating around an axis, which is normal to the air flow hitting said rotor hub blades, where each blade is extended radially from said rotor hub and the blade plan-form is in the shape and size of the cross section of the channel where the air hits said blades.

13. A wind turbine attached to convergent nozzle according to claim 2, having several wings span between two parallel circular disks, fixed to said disks in a circular manner thus the wings placed in air flowing channel where said flowing air creates aerodynamic forces on said wings, said aerodynamic forces created aerodynamic rotating moments, causing said disks to rotate around an axis normal to said disks' planes and parallel to said wings' spans.

14. A device according to claim 2 where the airflow's source is an artificial source driving airflow thru a nozzle.

15. A device according to claim 14, where the artificial air-source is a fan powered by any power source such as electrical, mechanical, steam, wind and so on.

16. A mobile device according to claim 2 that serves as a vehicle engine by transferring some of its turbine mechanical rotation power to the vehicle driving system and part of it to the electrical generator that generates electrical power to drive the artificial source flow.

17. A turbine to be attached to a convergent nozzle according to claim 2 comprises of at least one stage of axial turbine.

18. A device according to claim 2 where the inlet of first nozzle is raised above ground and its exhaust is connected by a pipe to a second nozzle below first nozzle said second nozzle contains a turbine.

19. A convergent nozzle according to claim 2 has an automatic control system to change inlet cross section area to maximize air speed at the nozzle throat to a desired speed.

20. A nozzle of claim 2 combined with control system that changes the nozzle throat cross-section area to achieve desired air speed at the throat.

21. A device of claim 5, where the turbines are placed before the throat or at the throat or after the throat.

22. A device according to claim 2 provided with a starter system that initiate air-turbine rotation to allow airflow entering the inlet, passing through the turbine and exiting the device.

23. A device according to claim 2 mounted on a rotating system so that the inlet can be rotated toward the coming wind at any angle relative to whig vector from 0 degree to 180 degrees.

24. A nozzle of claim 5 having a starting system that provides power to rotate the air turbine comprises of electrical motor and power supply like battery or electrical grid, said electrical motor is optionally the turbine electrical generator.

25. A wind-turbine starting system comprises a wind sensor, battery, and electrical motor that rotates the turbine in its operational direction so it sucks air and allows wind entering the nozzle to flow through the turbine blades.

26. A device according to claim 2 having a substantially vertical wing surface placed in the free wind, so coming wind generates aerodynamic force and moment on said wing thus this moment rotates the device toward the coming wind.

27. A device according to claim 2 having powered means to rotate said device toward the wind.

28. A nozzle of claim 2 and any air-turbine combined to work with it uses ice repellent means such liquids, or thermal heating by electrical currents or hot air to melt ice from the nozzle and turbine elements.

29. A device having a powered fan in its inlet claim 2, equipped with a turbine, said turbine driving a propeller which its blades faces free air, thus this device is a turbo-prop engine driving an aircraft.

30. A device according to claim 29 where the powered fan is driven by electrical motor or by the turbine mechanical power.

31. A turboprop engine according to claim 29 comprises an inner convergent nozzle equipped with a powered fan and turbine that provides energy to said powered fan and to additional bigger fan that push air into external nozzle so that this combination is two stages turbo-prop engine driving an aircraft.

32. A turboprop engine according to claim 2 having variable geometry convergent divergent nozzle.

33. A turboprop engine according to claim 2 having variable geometry convergent nozzle where a moveable part of the nozzle is deflected to push the airflow into opposite direction of the flow entering the so that the device is turboprop engine with thrust reverser, driving an aircraft.

34. A turboprop engine according to claim 2, where its nozzles incorporate fuel injectors and igniters to increase air flow temperature, internal energy, rate of mass flow and airflow speed of sound at the turbine thus increasing turbine energy production.

35. A device according to claim 2 that generates electricity from air internal energy independently of natural wind comprises a convergent nozzle equipped with first powered fan used to start the device and turbine that transfers air kinetic energy into mechanical energy which drives first powered fan and second preferably bigger powered fan and electrical generator that generates electricity.

36. A device according to claim 6 uses ice repellent means such liquids, or thermal heating by electrical currents or hot air to melt ice from the nozzle and the air-turbine elements.
